(19) United States
(12) Patent Application Publication
(10) Pub. No.: US 2022/0129443 A1
(43) Pub. Date: Apr. 28, 2022

(54) DOCUMENT MANAGEMENT SYSTEM AND RELATED METHOD

(71) Applicant: GENETEC INC., Saint-Laurent (CA)

(72) Inventors: Mathieu NADEAU, Montréal (CA); Sébastien NADEAU, Sainte-Thérèse (CA)

(21) Appl. No.: 17/081,432

(22) Filed: Oct. 27, 2020

(51) Int. Cl. G06F 16/23; G06F 16/21; G06F 21/60; H04L 9/30

(52) U.S. Cl. CPC G06F 16/2379; H04L 9/30; G06F 21/602; G06F 16/219

(57) ABSTRACT

Systems, methods, devices and computer readable media for accessing a document are described herein. A virtual file system comprising one or more virtual files is provided at a computing device. A document authoring application obtains a blockchain reference from a virtual file. The virtual file corresponds to a document stored in a blockchain by a document management system. The blockchain reference is indicative of the blockchain having stored therein the document. The document authoring application transmits a document access request comprising the blockchain reference to the document management system. The document management system receives a temporary file corresponding to a latest version of the document from the document management system. The document authoring application outputs at least in part the contents of the document from the temporary.

### TECHNICAL FIELD

The present disclosure relates generally to electronic document management, and, more particularly, to document management systems accessible by document authoring applications and related methods.

### BACKGROUND

Electronic document management systems are computer-based software programs that allow for managing the creation, use, and storage of electronic documents. Many electronic document management systems are also capable of recording the various versions created and modified by different users. An electronic document management system may be a standalone software application dedicated solely to management of electronic documents or may be part of an electronic content management systems that manages various types of files, including electronic documents. An electronic evidence management system typically allows for the storage, management and sharing of digital evidence, and is a form of electronic content management systems. An issue with existing evidence management systems is that a user may have to use a web-browser to interface with the evidence management system, which can be cumbersome, time consuming and/or inefficient when dealing with documents. Similar issues may exist for other electronic document management and/or content management systems. As such, there is room for improvement.

### SUMMARY

The present disclosure is generally drawn to systems, methods, devices, and computer readable media for accessing a document by a computing device, a document authoring application or a document management system.

In one aspect, there is provided a method for accessing a document by a document authoring application. The method comprises: obtaining, by the document authoring application, a blockchain reference from a virtual file of a computing device, the virtual file corresponding to a document stored in a blockchain by a document management system remote from the computing device, the blockchain reference indicative of the blockchain having stored therein the document; transmitting, by the document authoring application, a document access request to the document management system, the document access request comprising the blockchain reference; receiving, by the document authoring application, a temporary file corresponding to a latest version of the document from the document management system; and outputting, by the document authoring application, at least in part contents of the document from the temporary file.

In some embodiments, the method further comprises: transmitting, by the document authoring application, an audit request for an audit trail of the document to the document management system, the audit request comprises the blockchain reference; receiving, by the document authoring application, the audit trail from the document management system; and outputting, by the document authoring application, at least in part the audit trail.

In some embodiments the document authoring application comprises a software add-in for obtaining the blockchain reference, transmitting the document access request, receiving the temporary file, transmitting the audit request, receiving the audit trail and outputting the audit trail.

In some embodiments, the temporary file further comprises the blockchain reference.

In some embodiments, the audit request comprises the blockchain reference of the temporary file.

In some embodiments, the method further comprises: transmitting, by the document authoring application, a document save request to the document management system, the document save request comprises the blockchain reference of the temporary file and a current version of the document.

In some embodiments, the document authoring application is running on the computing device.

In some embodiments, the computing devices comprises at least one processing unit and at least one non-transitory computer-readable medium having stored thereon program instructions executable by the at least one processing unit for performing the method.

In some embodiments, the method further comprises providing, by the computing device, a virtual file system comprising the virtual file, the virtual file system corresponding to documents stored in blockchains by the document management system and authorized to be accessed by the computing device.

In some embodiments, a shell extension and/or a background service runs on the computing device, and the shell extension and/or the background service provide the virtual file system.

In some embodiments, obtaining the blockchain reference comprises retrieving the blockchain reference from the virtual file in response to a user request via the virtual file system to open the document corresponding to the virtual file.

In some embodiments, obtaining the blockchain reference comprises retrieving the blockchain reference from the virtual file in response to a user request via the document authoring application to open the document corresponding to the virtual file.

In some embodiments, the document has multiple versions and each version of the document is stored by a separate block of the blockchain.

In some embodiments, the document authoring application is running on at least one server remote from the computing device.

In some embodiments, the at least one server comprises at least one processing unit and at least one non-transitory computer-readable medium having stored thereon program instructions executable by the at least one processing unit for performing the method.

In one aspect, at least one non-transitory computer-readable medium has stored thereon program instructions executable by at least one processing unit for performing the method.

In one aspect, there is provided a method for accessing a document by a computing device. The method comprises: providing, by the computing device, a virtual file system comprising one or more virtual files, each one of the one or more virtual files corresponding to a respective document stored in a blockchain by a document management system; receiving, by the computing device, user input to open a document corresponding to a selected virtual file of the one or more virtual files, the selected virtual file comprises a blockchain reference indicative of the blockchain having stored therein the document; causing a document authoring application to transmit a document access request for the document corresponding to the selected virtual file to the document management system, the document access request comprising the blockchain reference; receiving, by the computing device, contents of the document corresponding to the selected virtual file; and outputting, by the computing device, at least in part the contents of the document.

In some embodiments, the method further comprises: receiving user input for an audit trail of the document; causing the document authoring application to transmit an audit request for the document to the document management system, the audit request comprises the blockchain reference; receiving, by the computing device, contents of the audit trail of the document; outputting, by the computing device, at least in part the contents of the audit trail.

In some embodiments, the document authoring application is running on the computing device.

In some embodiments, causing the document authoring application to transmit the document access request comprises transmitting, by the document authoring application, the document access request to the document management system.

In some embodiments, causing the document authoring application to transmit the audit request comprises transmitting, by the document authoring application, the audit request to the document management system.

In some embodiments, receiving the contents of the document comprises receiving, by the document authoring application, a temporary file comprising the blockchain reference and the contents of the document corresponding to the selected virtual file.

In some embodiments, the audit request comprises the blockchain reference of the temporary file.

In some embodiments, receiving the contents of the audit trail comprises receiving, by the document authoring application, the audit trail.

In some embodiments, the document authoring application comprises a software add-in for transmitting the document access request, receiving the temporary file, transmitting the audit request, receiving the audit trail and outputting the audit trail.

In some embodiments, the method further comprises: receiving user input to save a current version of the document; and causing the document authoring application to transmit a document save request to the document management system, the document save request comprises the blockchain reference and the current version of the document.

In some embodiments, the document authoring application is running on at least one server remote from the computing device and accessible by the computing device via a web browser running on the computing device.

In some embodiments, the document has multiple versions and each version of the document is stored by a separate block of the blockchain.

In one aspect, the computing devices comprises at least one processing unit and at least one non-transitory computer-readable medium having stored thereon program instructions executable by the at least one processing unit for performing the method.

In one aspect, at least one non-transitory computer-readable medium has stored thereon program instructions executable by at least one processing unit for performing the method.

In one aspect, there is provided a method for accessing a document by a document management system. The method comprises: receiving a document access request to access a document from a document authoring application, the document access request comprising a blockchain reference indicative of a blockchain having stored therein the document; identifying the blockchain corresponding to the blockchain reference and accessing a block of the blockchain storing a latest version of the document; and transmitting a temporary file corresponding to the latest version of the document to the document authoring application.

In some embodiments, the method further comprises: receiving an audit request for an audit trail of the document from the document authoring application, the audit access request comprising the blockchain reference; obtaining the audit trail of the blockchain corresponding to the blockchain reference; and transmitting the audit trail to the document authoring application.

In some embodiments, receiving the document access request from the document authoring application comprises receiving the document access request from a software add-in of the document authoring application configured to interface the document authoring application with the document management system.

In some embodiments, receiving the audit request comprises receiving the audit request from the software add-in of the document authoring application.

In some embodiments, the method further comprises: receiving a document save request from the document authoring application, the document save request comprises the blockchain reference and a current version of the document; identifying the blockchain corresponding to the blockchain reference of the document save request; and storing the current version of the document as a new block of the blockchain.

In some embodiments, storing the current version comprises: generating an encrypted version of the current version of the document based on encrypting the current version of the document with a symmetric encryption key; generating an encrypted version of symmetric key based on encrypting the symmetric encryption key with a public key of a user that created the current version of the document; and storing in the new block the encrypted version of the current version of the document and the encrypted version of symmetric key.

In some embodiments, accessing the block of the blockchain storing the latest version of the document comprises: obtaining a private key of a user that created the latest version of the document based on a user identifier stored in the block; decrypting an encrypted symmetric encryption key stored in the block with the private key to obtain a symmetric encryption key; and decrypting an encrypted version of the document stored in the block with the symmetric encryption key to obtain the latest version of the document.

In one aspect, the document management system comprises at least one processing unit and at least one non-transitory computer-readable medium having stored thereon program instructions executable by the at least one processing unit for performing the method.

In one aspect, at least one non-transitory computer-readable medium has stored thereon program instructions executable by at least one processing unit for performing the method.

Any of the above features may be used together in any suitable combination.

### DESCRIPTION OF THE DRAWINGS

Reference is now made to the accompanying figures in which:

FIG. 1 is a block diagram illustrating a document authoring application and a document management system, in accordance with one or more embodiments;

FIG. 2A is a block diagram illustrating the document management system and a computing device with the document authoring application, in accordance with one or more embodiments;

FIG. 2B is a block diagram illustrating the document management system, a computing device and a computing infrastructure with the document authoring application, in accordance with one or more embodiments;

FIG. 3 is a block diagram illustrating an example configuration of the computing device and the document management system, in accordance with one or more embodiments;

FIG. 4 is a block diagram illustrating an example of a virtual file corresponding to a document stored in a blockchain, in accordance with one or more embodiments;

FIG. 5 is a file explore window providing a virtual file system, in accordance with one or more embodiments;

FIG. 6A is a document authoring application having a web-based interface for displaying document information, in accordance with one or more embodiments;

FIG. 6B is a portion of the web-based interface of FIG. 6A, in accordance with one or more embodiments;

FIG. 6C is a document authoring application having a web-based interface for displaying an audit trail, in accordance with one or more embodiments;

FIG. 7A is a block diagram of an example blockchain configuration, in accordance with one or more embodiments;

FIG. 7B is a block diagram of another example blockchain configuration, in accordance with one or more embodiments;

FIG. 8A is a flowchart illustrating an example method for accessing a document by a computing device, in accordance with one or more embodiments;

FIGS. 8B, 8C, and 8D are flowcharts illustrating optional steps of the method of FIG. 8A, in accordance with one or more embodiments;

FIG. 9A is a flowchart illustrating an example method for accessing a document by a document authoring application, in accordance with one or more embodiments;

FIGS. 9B, 9C, and 9D are flowcharts illustrating optional steps of the method of FIG. 9A, in accordance with one or more embodiments;

FIG. 10A is a flowchart illustrating an example method for accessing a document by a document management system, in accordance with one or more embodiments;

FIGS. 10B, 10C, and 10D are flowcharts illustrating optional steps of the method of FIG. 10A, in accordance with one or more embodiments; and

FIG. 11 is a schematic diagram of an example computing device, in accordance with one embodiment.

It will be noted that throughout the appended drawings, like features are identified by like reference numerals.

### DETAILED DESCRIPTION

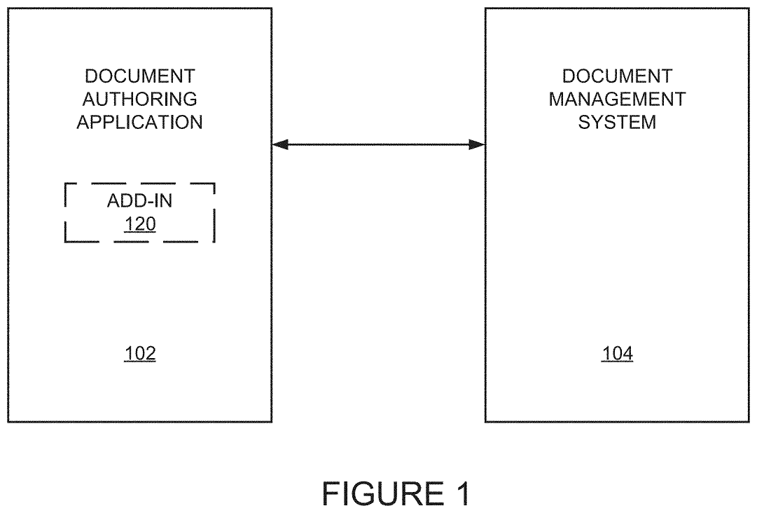

With reference to FIG. 1, there is illustrated an example of a document authoring application 102 and a document management system 104. The document authoring application 102 is configured to interface with the document management system 104 in order to access electronic documents managed by the document management system 104.

The document management system 104 is configured to manage electronic documents, such as, for example, to create, store and/or track electronic documents. As described in further detail in this document, the document management system 104 is configured to provide version control so as to maintain a record of who and how a current document was created and edited, and to record the different versions of the document. The document management system 104 is also configured to allow for an audit trail of a document to be generated in order to reconstruct who did what to a document during its lifecycle. Accordingly, the system 104 may be referred to as an “auditable document management system”. The document management system 104 comprises a computing infrastructure and document management software. The document management software is configured to implement any of the functionality of the document management system 104 described herein. The computing infrastructure of the document management system 104 may comprise one or more computing devices, computers, servers, server clusters, mainframes, computing clusters, cloud computing systems, distributed computing systems, portable computing devices, or the like. While the document management system 104 is referred to as a “document management system” it may actually be a “file management system” or a “content management system” that manages various types of files, where documents are one type of file that is managed by such system 104. In other words, the system 104 is referred to as a “document management system”, as it is configured to at least be able to manage electronic documents and may be configured to have other functionality. The system 104 may be an evidence management system, for example, it may be running Clearance™ evidence management software provided by Genetec™.

The document authoring application 102 may be any suitable document authoring computer-based software application that allows documents to be authored therein. The document authoring application 102 may also be known as a “word processor”, which is a computer program that typically provides for input, editing, formatting and output of text, often with some additional features. The document authoring application 102 may be any suitable document authoring application that is configured to interface with the document management system 104. The document authoring application 102 may be Microsoft™ Word™, Excel™, PowerPoint™ or any other suitable Microsoft™ application that documents may be authored therein. The document authoring application 102 may be configured to have a software add-in 120 which is any suitable software extension that allows the document authoring application 102 to interface with the document management system 104. The add-in 120 may be referred to as a “software extension”, “plug-in” or “add-on”, and is a type of computer program or software component that is meant to extend or add on to what the base application (i.e., the document authoring application 102) is configured to do. The add-in 120 is specific to the document management system 104, and thus may be referred to as a “document management system add-in” or a “document management system software extension”. In alterative embodiments, the document authoring application 102 may be a standalone application that is configured to interface with the document management system 104 (i.e., it already includes program code that allows it to communicate with the document management system 104), rather than using an add-in that provides this functionality. In yet other embodiments, the document authoring application 102 is unable to directly communicate with the document management system 104; rather, an interface (e.g., shell extension and/or background service) separate from the document authoring application 102 allows for the communication with the document management system 104. The document authoring application 102 may be any suitable text editor, for example, such as Notepad™.

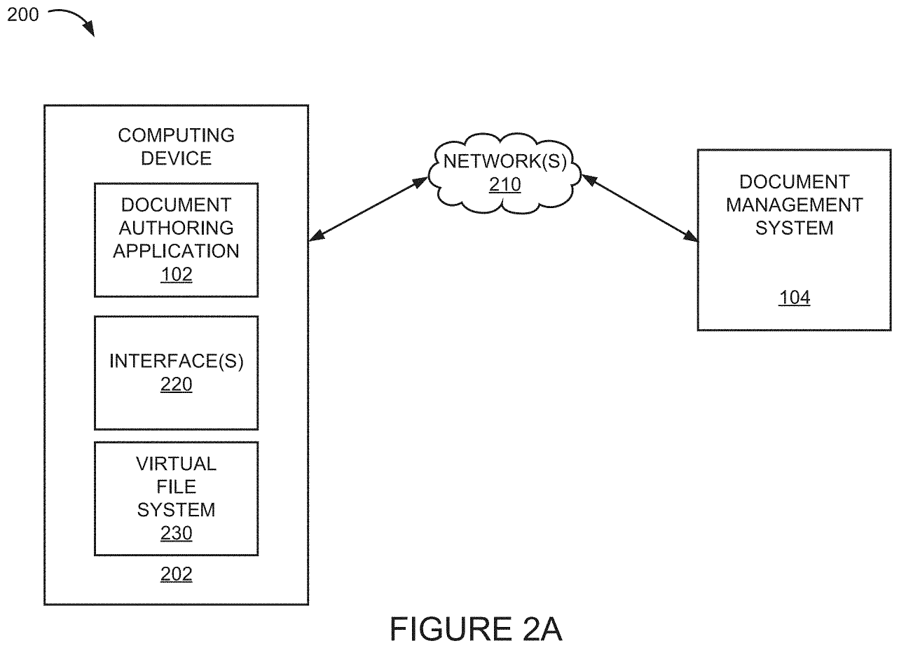

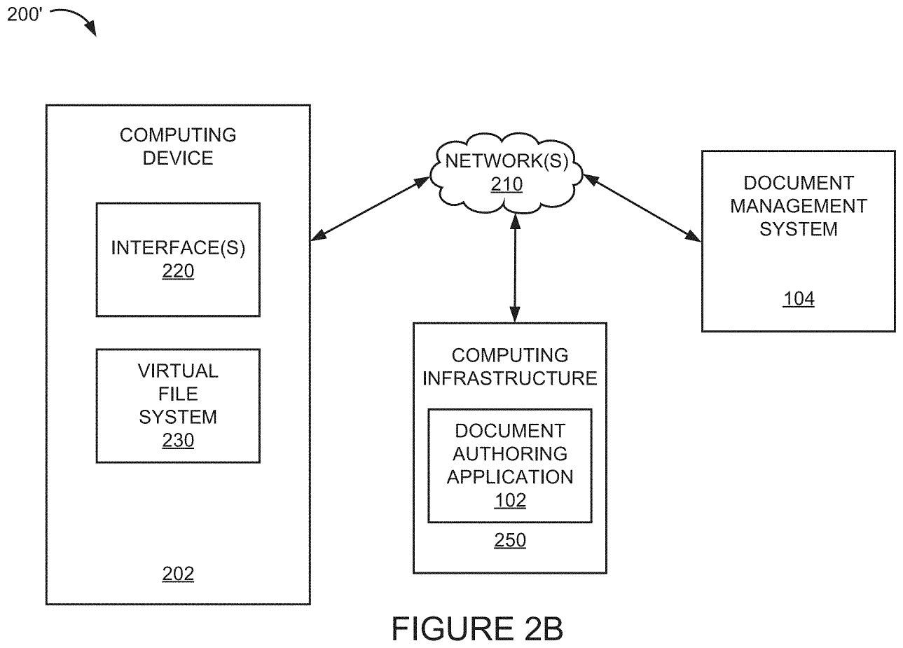

With reference to FIG. 2A, there is illustrated an example environment 200 where a computing device 202 is configured to communicate with the document management system 104 over one or more networks 210. As illustrated, the computing device 202 may have the document authoring application 102 installed thereon and may be configured to run the document authoring application 102. The computing device 202 may be a computer, a mobile phone, a smart phone, a tablet, a laptop computer, a workstation, or the like. The network(s) 210 may comprise one or more public networks (e.g., the Internet) and/or one or more private networks. The network(s) 210 may comprise one or more of a personal area network (PAN), local area network (LAN), mesh network, metropolitan area network (MAN), wide area network (WAN), wireless network, Wi-Fi network, Bluetooth network, cellular network, the Internet, and/or any other suitable network(s). The computing device 202 has one or more interfaces 220. The interface(s) 220 may be used for interfacing with one or more external devices, systems, networks and/or other computing infrastructures and/or for interfacing between different software or program components of the computing device 202. The interface(s) 220 may be hardware-based and/or software-based, depending on the functionality of a given interface. The interface(s) 220 may be configure to allow the computing device 202 to communicate with the document management system 104. The computing device 202 may be configured to provide at least one virtual file system 230, which is an abstract layer on top of the file system of the computing device 202. The virtual file system 230 is configured to allow the computing device 202 to have access to files (e.g., documents) of the document management system 104. The virtual file system 230 may be provided via one or more of the interface(s) 220.

With additional reference to FIG. 2B, there is illustrated a variant 200′ of the environment 200 of FIG. 2A. In this example environment 200′, a computing infrastructure 250 that is remote from the computing device 202 has the document authoring application 102 installed therein and may be configured to run the document authoring application 102. In other words, instead of the computing device 202 using a local version of the document authoring application 102 running on the computing device 202, the computing device 202 communicate via one or more of the interfaces 220 with the computing infrastructure 250 to use the document authoring application 102. For example, the document authoring application 102 may be the cloud-based version of Microsoft™ Word™, Excel™, PowerPoint™ or any other suitable Microsoft™ application, such as, for example provided by Microsoft™ Office 365™. The document authoring application 102 may be any other suitable cloud-based document authoring application. The computing infrastructure 250 may comprise one or more computing devices, computers, servers, server clusters, mainframes, computing clusters, cloud computing systems, distributed computing systems, portable computing devices, or the like. While in FIG. 2B the computing device 202 is illustrated as not have any document authoring application, the computing device 202 may actually have the document authoring application 102 installed thereon but a user may choose to use the document authoring application 102 running on the remote computing infrastructure 250. Accordingly, in some embodiments, a local version of the document authoring application 102 executed on the computing device 202 may be used, and, in some embodiments, a web-based version (e.g., provided via a web-browser running on the computing device 202) may be used. The choice of whether a location version or a web-based version of the document authoring application 102 is used may be a choice of the user of the computing device 202.

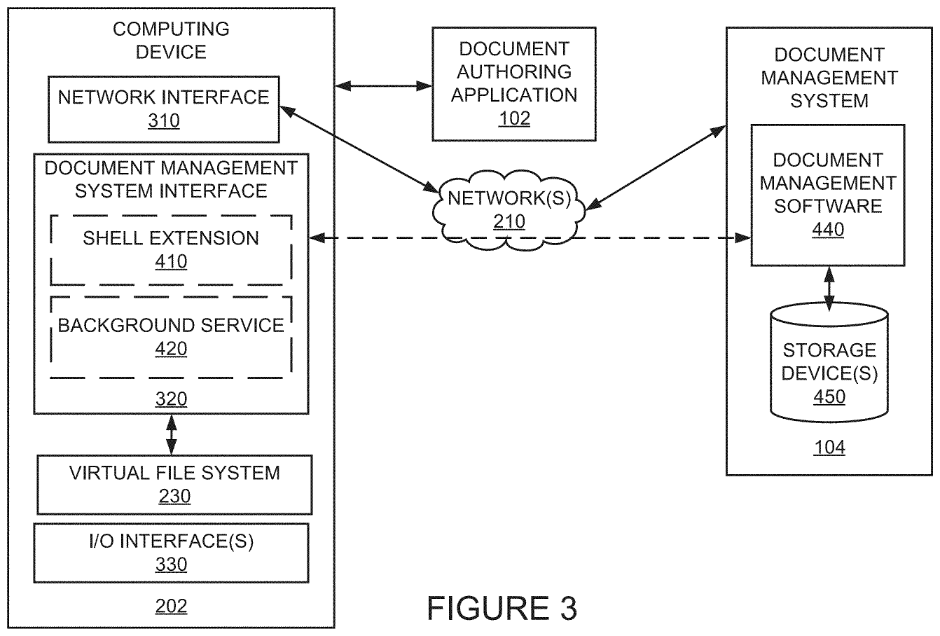

With reference to FIG. 3, a specific and non-limiting example configuration of the computing device 202 and the document management system 104 is illustrated, which shows how the computing device 202 may interface with the document management system 104. While the document authoring application 102 is shown as being external of the computing device 202 in FIG. 3, the document authoring application may be running on the computing device 202 or the remote computing infrastructure 250.

In the example of FIG. 3, the interfaces 220 of the computing device 202 comprise one or more network interfaces 310. The network interface(s) 310 may comprise wired and/or wireless network interface(s) for connecting the computing device 202 to the network(s) 210. The network interface(s) 310 may comprise one or more network interface controllers (NIC), also known as a network interface card, network adapter, LAN adapter or physical network interface, and is also referred to by other similar terms.

In this example, the interfaces 220 of the computing device 202 comprise a document management system interface 320. The document management system interface 320 comprise one or more software-based components running on the computing device 202 that allows the computing device 202 to interface with the document management system 104. For example, a shell extension 410 and/or a background service 420 may be used. While the document management system interface 320 is illustrated as a single interface, it may actually be two separate interfaces one corresponding to the shell extension 410 and the other corresponding to the background service 420. The document management system interface(s) 320 may vary depending on the configuration (e.g., the operating system) of the computing device. The shell extension 410 is a software component that extends the abilities of the operating system (e.g., a Windows™ operating system provided by Microsoft™, or any other suitable operating system).

The shell extension 410 is specific to the document management system 104 in order to allow the computing device 202 to interface with the document management system 104, and more specifically with the document management software 440 (e.g., Clearance™) of the document management system 104. The background service 420 is a software component that runs in background while the operating system of the computing device 202 is running. The background service 420 may launch on start-up of the operating system of the computing device 202. The background service 420 is specific to the document management system 104 in order to allow the computing device 202 to interface with the document management system 104, and more specifically with the document management software 440 (e.g., Clearance™) of the document management system 104. The shell extension 410 and the background service 420 may function in combination to intercept shell events (e.g., listing a directory in file explorer, opening a file, etc.) and to communicate with the document management software 440 (e.g., Clearance™) of the document management system 104 based on the type of shell event. For example, when a user requests to open a virtual file of the virtual file system 230, the shell extension 410 and the background service 420 may function in combination to intercept the shell opening event for this user request, and transmit a document access request to the document management software 440 to obtain a temporary file corresponding to the virtual file in order to open the file.

The document management system interface 320 (e.g., the shell extension 410 and/or the background service 420) may be configured to provide the virtual file system 230. For example, after a user of the computing device 202 is authenticated with the document management system 104, the virtual file system 230 is made available to the user. The authentication of the user may occur via the document management system interface (e.g., the shell extension 410 and/or the background service 420). For example, when the user logs in to the computing device 202, authentication may automatically occur. By way of another example, the user may request authentication from the document management system 104 via the document management system interface 320 (e.g., a stand alone application running on the computing device 202, via a web browser running on the computing device 202, etc.). The virtual file system 230 may comprise at least one virtual file corresponding to at least one document stored by the document management system 104, and in particular by the document management software 440. The virtual file system 230 corresponds to files (e.g., documents) managed by the document management system 104 and authorized to be accessed by the computing device 202 according to data access permissions and/or rights. For instance, after the user is authenticated, the virtual file system 230 made available at the computing device 202 corresponds to files (e.g., documents) managed by the document management system 104 and authorized to be accessed by the user of the computing device 202 according to the data access permissions (or user rights) for that user. The file(s) (e.g., the document(s)) stored by the document management system 104 are stored in one or more storage devices 450 associated with the document management system 104. The storage device(s) 450 may be part of the document management system 104 or may be separate from the document management system 104. That is, the computing infrastructure of the document management system 104 that runs the document management software 440 may be separate from computing infrastructure with the storage device(s) 450 that stores the document(s), or may be part of the same computing infrastructure.

In this example, the interfaces 220 of the computing device 202 comprise one or more input and/or output (I/O) interfaces 330 for connecting to one or more input and/or output devices. The 1/O interface(s) 330 may be connected to a display device (not illustrated) in order to output a graphical user interface (GUI) in which the document authoring application 102 can be accessed by a user. In some embodiments, the computing device 202 comprises the display device. The display device may be a cathode ray tube display device, a light emitting diode (LED) display device, a liquid crystal display (LCD) display device, a touch screen, or any other suitable display device. The display device may be part of the computing device 202 or separate therefrom. The 1/O interface(s) 330 may be connected to any suitable input device(s), for example, such as a keyboard, a mouse, a stylus, a touch screen, and/or the like.

The interfaces of the computing device 202 may vary depending on practical implementations. One or more of the interfaces shown in FIG. 3 may be omitted in some embodiments. Similarly, the computing device 202 may comprise one or more additional interfaces not shown in FIG. 3.

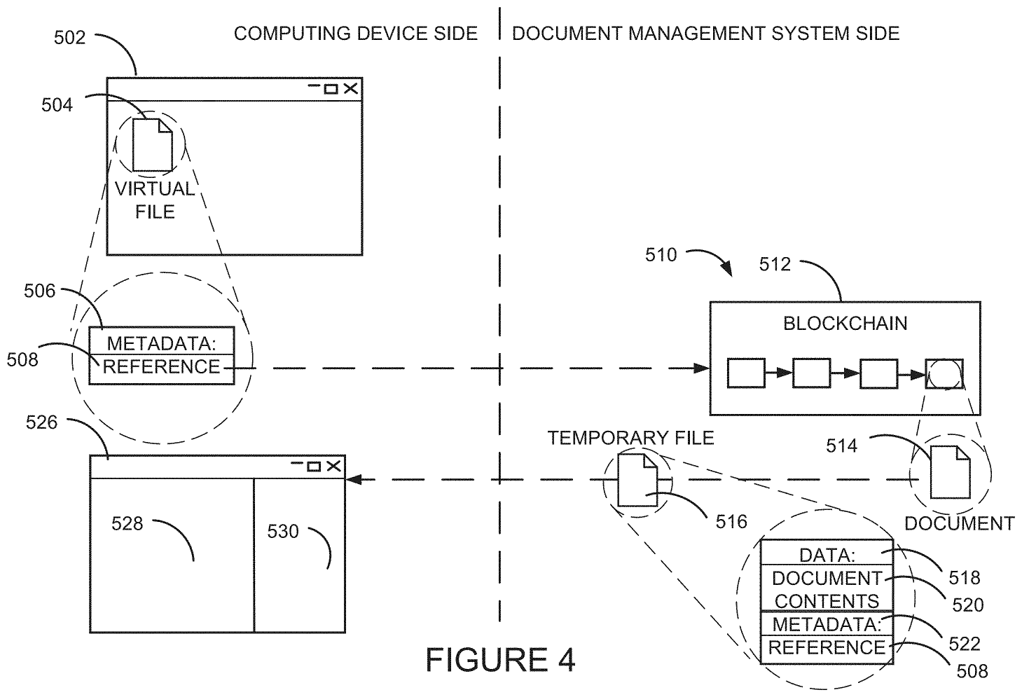

With reference to FIG. 4, there is illustrated an example showing the association between a virtual file 504 provided at the computing device 202 and a document 514 managed by the document management system 104. As illustrated, a file explorer window 502 displays the virtual file system 230, which has the virtual file 504. The virtual file 504 comprises metadata 506 having a reference 508 to a data structure 510 corresponding to the virtual file 504 that is managed by the document management system 104. The data structure 510 stores the document 514 corresponding to the virtual file 504. The data structure 510 may store multiple versions of the document 514 corresponding to the virtual file 504. The data structure 510 is stored in the storage device(s) 450. The virtual file 504 excludes (i.e., does not contain) the contents of the document 514 that it represents. In this example, the data structure 510 is a blockchain 512. The data structure 510 may vary depending on practical implementations, and blockchain is one type of implementation for the data structure 510. Various examples and embodiments are described herein with reference to blockchain being the data structure used, and these examples and embodiments may be implemented with any other suitable data structure where appropriate. Accordingly, the term “blockchain” may be interchanged with “data structure” in the various examples and embodiments described herein, in order to provide a non-blockchain based implementation.

The term “blockchain” is defined as any type of data structure with immutable back-linked data blocks thereby forming a chain of data. Each block in the blockchain is implemented such that any modification of payload data of a given block is detectable thus making the blockchain immutable. The blockchain can be implemented by having each block in the blockchain store in its metadata a hash signature of the previous block (other than the first block in the blockchain) and a hash signature of the current block's payload data.

In this example, the blockchain 512 stores at least one version of the document 514. When the user requests to open the virtual file 504 (e.g., double clicks on the virtual file 504 or makes a request to open the virtual file 504 with the document authoring application 102), a request is made for the document 514 corresponding to the virtual file 504 (referred herein as the “document access request”). The document access request is transmitted by the document authoring application 102 to the document management system 104. More specifically, the add-in 120 may generate the document access request and may transmit the document access request to the document management software 440. Any of the requests made by the add-in 102 may be representational state transfer (REST) calls or requests. Each REST call comprises the reference 508. The document access request comprises at least the reference 508 obtained from the metadata 506 of the virtual file 504. The document access request typically also comprises identification information (e.g., identity of the computing device 202 or the computing infrastructure 250 that the request is being transmitted therefrom, the identity of the user making the request, etc.). The document management system 104 identifies the data structure 510 corresponding to the data structure reference 508 (e.g., the blockchain 512 corresponding to the blockchain reference 508), and then obtains the document 514. In this example, the document management system 104 obtains the latest version of the document 514 from the latest block of the blockchain 512 storing the document 514. The document management system 104 then transmits a temporary file 516 corresponding to the document 514 to the document authoring application 102. The temporary file 516 comprises data 518 comprising the contents 520 of the document 514. The temporary file 516 comprises metadata 522 comprising the reference 508. In this example, a graphical user interface window 526 displays the document authoring application 102 (e.g., a graphical user interface window of the document authoring application 102, a graphical user interface window of a web-browser, etc.). In some embodiments, as illustrated, a first panel 528 of the graphical user interface window 526 is configured to display the contents 520 of the document 514 obtained from the temporary file 516 and a second panel 530 of the graphical user interface window 526 is configured to display document information and/or an audit trail for the document 514. The first panel 528 of the graphical user interface window 526 may be the standard interface of the document authoring application 102 used for viewing and/or editing of a document. The second panel 530 of the graphical user interface window 526 may be used to provide a web-based interface within the document management system 104. The second panel 530 may be provided by the add-in 120 of the document authoring application 102. The document information and/or the audit trail displayed in the second panel 530 may be obtained from the document management system 104 by the document authoring application 102 (e.g., by the add-in 120) transmitting a document information request and/or an audit request with the reference 508 associated with the document 514 displayed in the first panel 528. The document authoring application 102 (e.g., the add-in 120) receives the document information and/or the audit trail and then outputs the document information and/or the audit trail in the second panel 530.

While FIG. 4 shows a single virtual file 504, it should be appreciated that the virtual file system 230 may comprise a plurality of virtual files each respectively corresponding to a blockchain that has stored therein one or more versions of a document. Similarly, while FIG. 4 shows a single blockchain 512, the document management system 104 may manage a plurality of blockchains, where each blockchain in the plurality corresponds to a document and has stored therein one or more versions of the document.

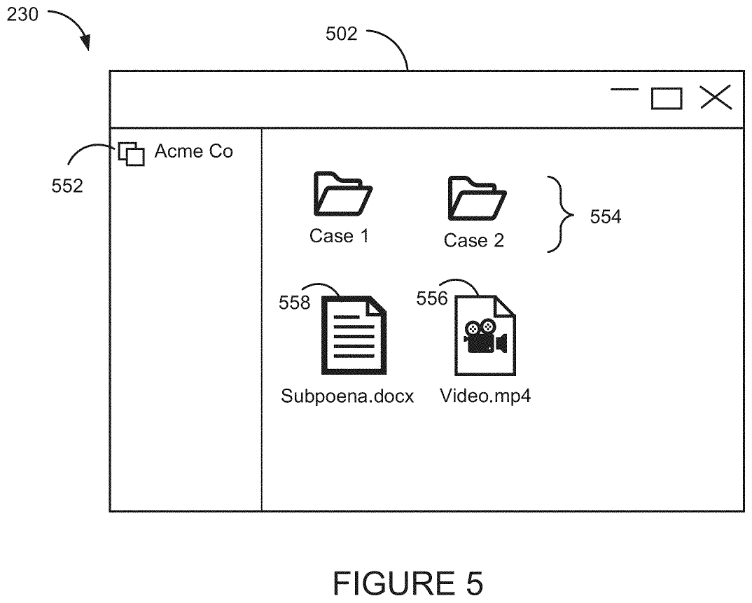

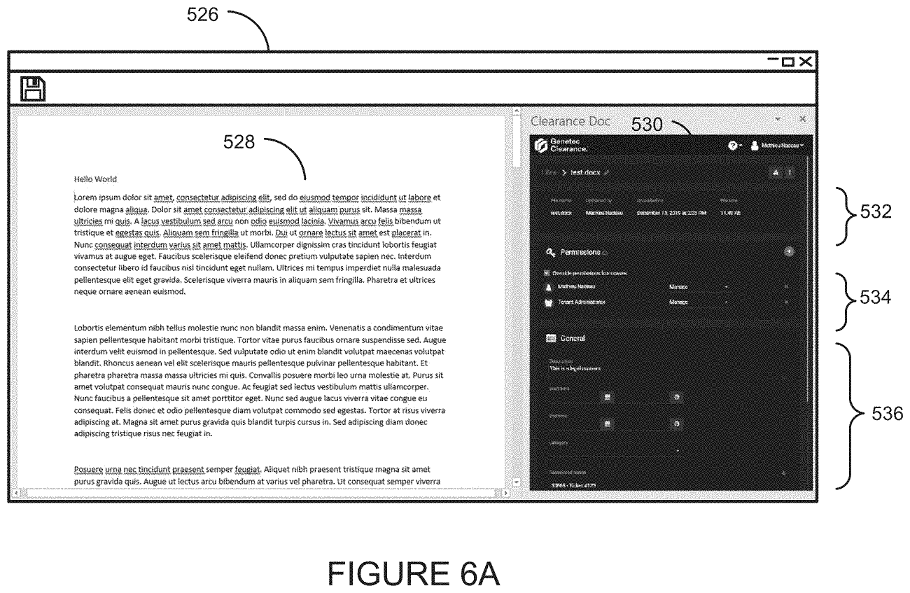

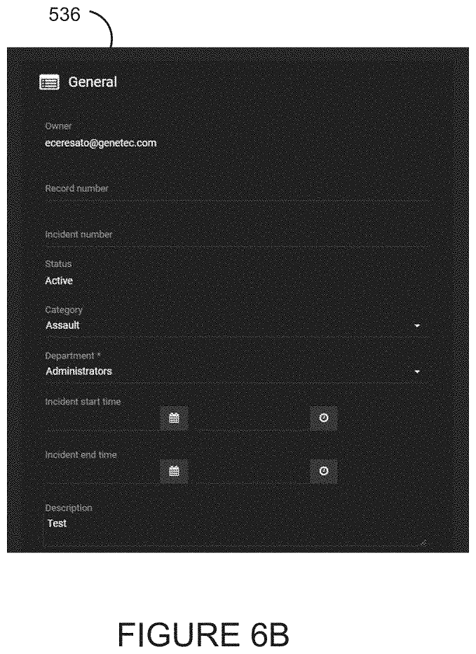

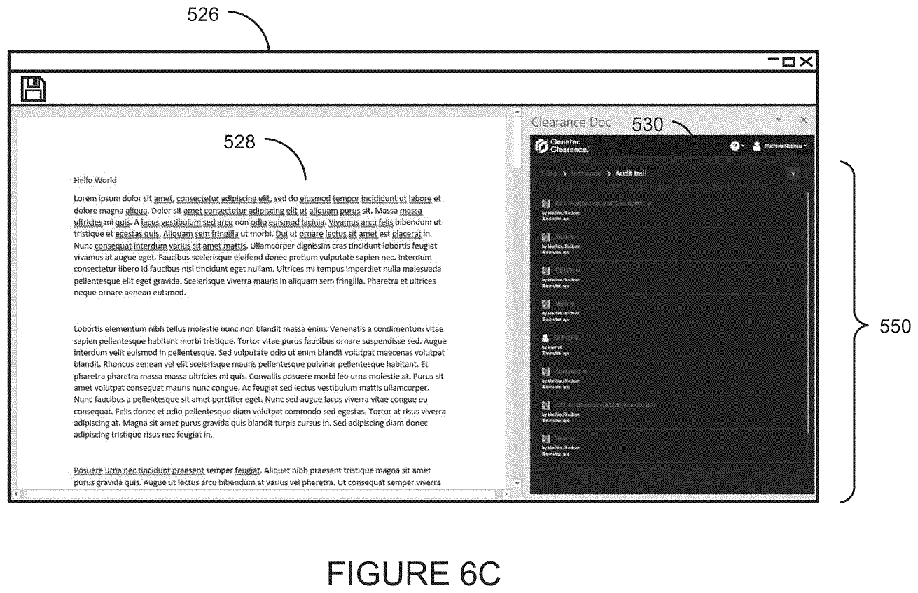

With reference to FIGS. 5, 6A, 6B and 6C, a specific and non-limiting example of the implementation of the computing device 202, the virtual file system 230, the document authoring application 102 and the document management system 104 will now be described. In this example, the computing device 202 is running a Windows™ operating system provided by Microsoft™, the shell extension 410 and the background service 420 are configured to provide the virtual file system 230, the document management software 440 of the document management system 104 is the evidence management system software Clearance™ provided by Genetec™, and the document authoring application 102 is Microsoft™ Word™ which has an add-in 120 that allows Microsoft™ Word™ to interface with Clearance™.

As shown in FIG. 5, the file explorer window 502 for the virtual file system 230 can be displayed via the GUI of the computing device 202. In this example, the virtual file system 230 can be accessed by selecting an icon 552 that represents the virtual file system 230 available to the authenticated user of the computing device 202. In this example, the virtual file system 230 comprises a plurality of files and folders that are managed by the evidence management system 104. More specifically, FIG. 5 shows two virtual file folders 554, a virtual video file 556 and a virtual Microsoft™ Word™ document file 558. When the user requests to open the virtual document file 558 (e.g., double clicks on the virtual document file 558 or makes a request to open the virtual document file 558 with the document authoring application 102) this causes the document authoring application 102 via the add-in 120 to interface with the evidence management system 104 to obtain a temporary file corresponding to a latest version of the document represented by the virtual document file 558. More specifically, the add-in 120 transmits a document access request comprising the reference obtained from the metadata of the virtual file corresponding to the document that the user has requested to open. The add-in 120 receives the temporary file and causes at least in part the contents of the temporary file to be displayed in the document authoring application 102.

As shown in FIG. 6A, the graphical user interface window 526 corresponding to the document authoring application 102 displays in the first panel 528 at least in part the contents of the document as conveyed by the temporary file and displays in the second panel 530 the document information, which may be set and/or modified via the second panel 530. In this example, the second panel 530 is a web-based interface, also referred to as a “web view”, which is a web browser rendering in the document authoring application 102 configured to interface with the document management system 104. In this example, the add-in 120 is configured to provide the web-based interface in the document authoring application 102. When the document displayed in the first panel 528 is opened, the add-in 120 transmits a document information request comprising the blockchain reference associated with that document to the document management system 104. The document management system 104 then processes the document information request to obtain the document information from the blockchain associated with the blockchain reference. The document management system 104 then transmits the document information, which is received by the add-in 120 and displayed in the second panel 530. Alternatively, when the add-in 120 transmits the document access request to the document management system 104, the document management system may also transmit the document information along with the temporary file for that document. In this example, the web-based interface has a file area 532 that allows the user to set and/or edit the file name for the document, to view the file name, the username of the user that saved the file, the timestamp and the file size. The web-based interface also has, in this example, a permissions area 534 to manage the data access permissions for the document (e.g., set which users have permissions to view and/or edit the document). The web-based interface also has, in this example, a general information area 536 that allows a user to set and/or edit various document settings. In some embodiments, as shown in FIG. 6B, the general information area 536 comprises a name or owner section, a record number section, an incident number section, a status section, a category section, a department section, an incident start and end time section, and a description section. Various section shown in FIG. 6B may be omitted and other section may be added, depending on practical implementations. The various areas 532, 534, 536 of the web-based interface 530 may allow the user to set various document settings for the document displayed in the first panel 528 and managed by the document management system 104. When the user updates the document settings, a document settings request comprising the updates to the document settings and the blockchain reference associated with the document is transmitted to the document management system 104 from the add-in 120. In some embodiments, the documents settings request may comprise a record or an incident number used to associate the document to an evidence matter comprising one or more files being managed by the system 104.

As shown in FIG. 6C, the graphical user interface window 526 corresponding to the document authoring application 102 displays in the first panel 528 at least in part the contents of the document as conveyed by the temporary file and displays in the second panel 530 the audit trail 550 for the document represented by the virtual document file 558. In this example, the audit trail 550 comprises a listing of views and edits for the document. This listing includes which user viewed and edited each version of the document and a timestamp of when the views and edits occurred. The user may be able to request to view a previous version of the document via the web-based interface 530 of the document authoring application 102, for example, by selecting a previous version as provided by the listing and requesting to access the previous version (e.g., by clicking on the previous version), which is then provided for display in the first panel 528 in a similar manner to that of the latest version of the document. In some embodiments, the previous version of the document may be made read-only.

It should be appreciated that by having the shell extension 410 and/or background service 420 running on the computing device 202, this allows for the virtual file system 230 with virtual files corresponding to files (e.g., documents) stored by the document management system 104 to be available at the computing device 202, which may otherwise only be accessible by using a web-browser in communication with the document management system 104 (e.g., the Clearance™ evidence management system).

It should also be appreciated that by having the add-in 120 configured to provide the web-based interface 530 in the graphical user interface window of the document authoring application 102, this allows for a user to seamlessly interact with the document management system 104, which may otherwise only be accessible by using a separate web-browser in communication with the document management system 104 (e.g., the Clearance™ evidence management system).

While in FIG. 5 a single virtual file system is shown, in some embodiments a plurality of virtual file systems may be provided at the computing device 202. The user interface may comprise a plurality of icons, similar to the icon 552, where each icon represents a respective virtual file system. The different virtual file systems may be associated with different users and may be linked to different tenants.

The authentication used to provide the virtual file system(s) may vary depending on practical implementations. An authenticated user of the virtual file system may be different from the authenticated user of the computing device 202. In other words, for example, the authenticated Windows™ user may be different from the authenticated user of the document management system software (e.g., Clearance™). The user may be able to authenticate with the document management system software via the web-based interface 530 provided by the add-in 120. The user of the computing device 202 may be able to authenticate multiple times with the document management system software via the web-based interface 530. Each authentication of a user and/or a tenant results in the corresponding virtual file system(s) associated with that user and/or tenant being made available at the computing device 202.

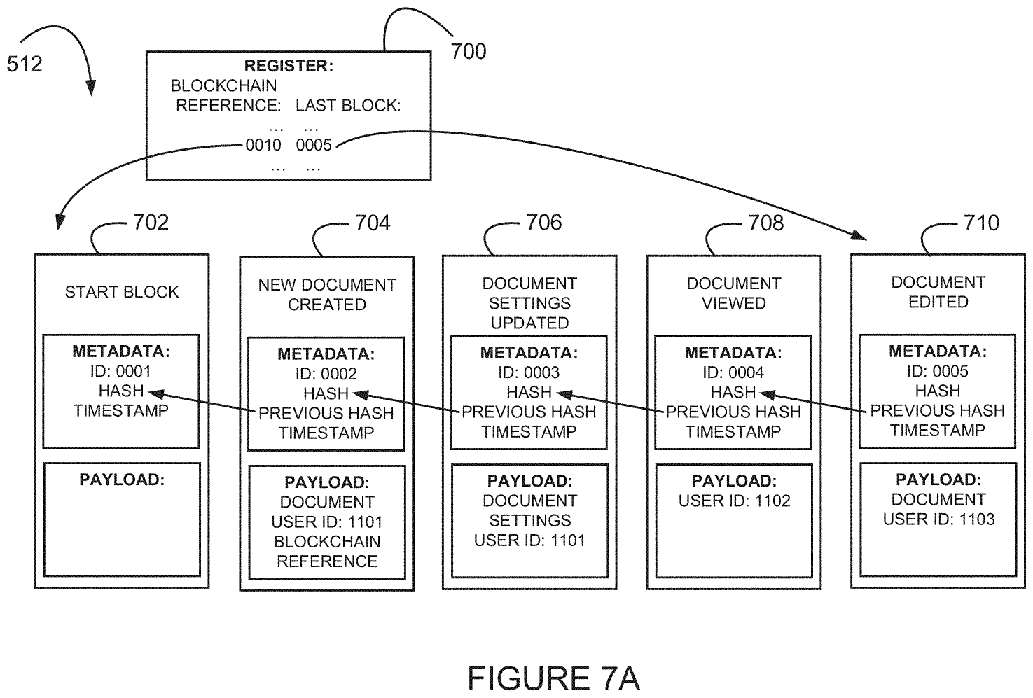

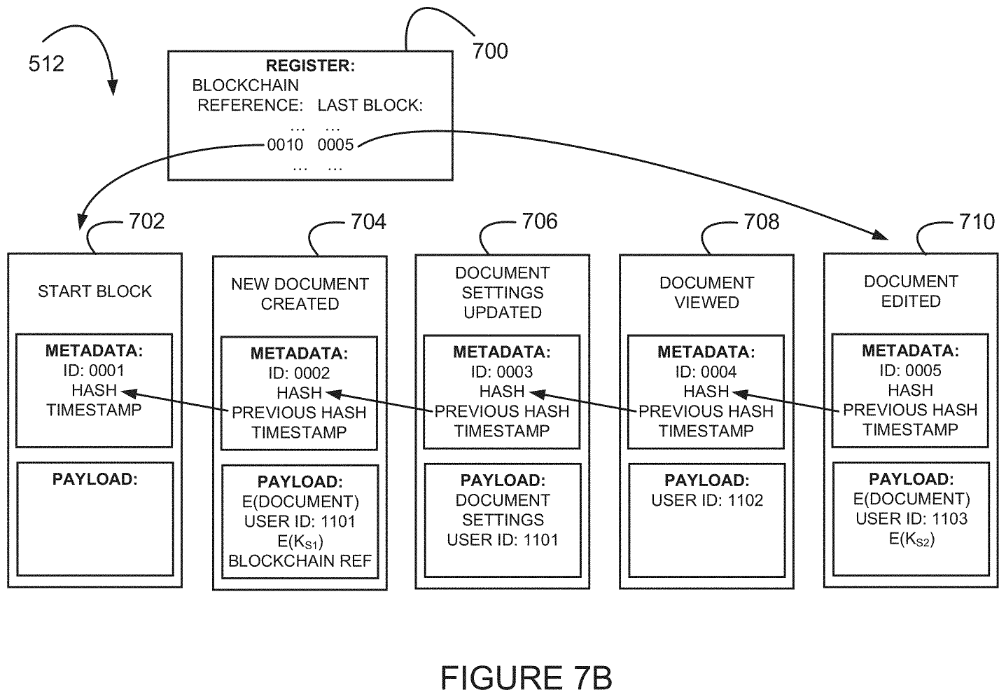

With reference to FIG. 7A, a specific and non-limiting example of the blockchain 512 is illustrated. When the document management system 104 receives a request to create a new document or save a new document not yet managed by the document management system 104, the document management system 104 creates a new blockchain, such as the blockchain 512. The system 104 initiates a new starting block 702 for the document 514. The blockchain 512 may be initialized by referencing a signed start block 702. A signed start block means that the block is cryptographically signed by an external trusted system (e.g. a certificate authority signing the block, for example, by using SHA256). Accordingly, the signed start block 702 may comprise a signature by the external trusted system and a timestamp of the time of signing by the external trusted system. Alternatively, the blockchain 512 may be initialized by referencing a block of a global blockchain. A global blockchain is a blockchain that may contain no useful payload data but only serves as a secure starting point to initiate new blockchains. In the case of a “global blockchain”, a new block, such as the block 702, is added to the global blockchain every time another blockchain is initialized. In yet further cases, the start block 702 may be omitted and/or combined with the new document created block 704. In some embodiments, the start block 702 may be a new block in any other suitable blockchain managed by the system 104.

As is known in blockchain technology, each new block of the blockchain 512 comprises the hash signature of the previous block, such that undetected data tampering is almost impossible. Any suitable cryptographic hash function may be used to generate the hash signature of a given block from the payload data of that block. A part from the first block 702, all blocks further have, at a minimum, the hash signature of the previous block and their own hash signature of their payload data. The data to be stored in a current block may be added in the block's payload, and thereafter used in the hash signature calculations for the current block.

Each block of the blockchain 512 may comprise metadata (e.g., one or more of: block identifier, hash signature of the previous block, user identifier of the user that cause the current block to be added, hash signature of the current block, timestamp, blockchain reference, etc.) and payload data (e.g., the document, document settings and/or permissions, user identifier of the user that cause the current block to be added, blockchain reference, etc.). The configuration of what type of data is stored in the metadata and the payload data may vary depending on practical implementations.

In this example, the document management system 104, generated a new document created block 704 when the document management system 104 received a request to create a new document or to save a new document not yet managed by the document management system 104. The new document created block 704 comprises in its payload data a first version of the document, a user identifier (in this example, 1101) of the user that created the first version of the document, and the blockchain reference. Alternatively, the user identifier and/or the blockchain reference may be stored in the metadata of this block 704. The metadata of the new document created block 704 comprises a block identifier (ID), the hash signature of the previous block (“previous hash”), the hash signature of the payload data (“hash”) and a timestamp.

The block identifiers may be globally unique identifiers (GUID), randomly generated alphanumeric identifiers that are to be assigned to every block or any other suitable identifiers. A given block identifier may correspond to an address for where that block is stored in the storage device 450. In some embodiments, a given block identifier (or address) is the hash for that block, for example, when content-addressable storage is used.

The document management system 104, in this example, generated a settings update block 706 when the document management system 104 received a settings request to modify the document settings of the document 514 stored in the blockchain 512. For instance, the document settings may be to update the data access permission to the document 514 to allow a second and third user (e.g., with user identifiers 1102, 1103) to access (e.g., view and/or edit) the document 514.

In this example, the document management system 104, generated a document viewed block 708 when the document management system 104 received a document access request In this example, the payload data of the document viewed block 708 comprises the user identifier (e.g., 1102) of the user that accessed and view the document 514 of the blockchain 512.

The document management system 104, in this example, created a document edited block 710 when the document management system 104 received a document save request. In this example, the payload data of the document edited block 710 comprises a new version of the document 514 and the user identifier (e.g., 1103) of the user that saved the new version of the document 514 to the blockchain 512.

The document management system 104 may comprise a register 700. The register 700 may store blockchain references and last block identifiers. The last block of a blockchain may be referred to as the “head block”. The register 700 may store for each blockchain reference a corresponding identifier for the last block of that blockchain. In other words, a register 700 may be used to have a respective pointer to each blockchain, which can be identified using the blockchain reference. The register 700 may be any suitable database and/or data structure that stores the blockchain references and the last block identifiers.

When the document management system 104 receive a request (e.g., a document access request, a document save request, a setting request, etc.), the document management system 104 may search the register 700 with the blockchain reference provided by the request to identify the corresponding blockchain, and then the document management system 104 may then perform the functions of that request on the identified blockchain. Each request may result in a new block being added to the blockchain, thereby maintaining an accurate record of events.

It should be appreciated that by storing each version of the document as a separate block and by storing additional information (e.g., user identifiers, document settings, etc.) that the document management system 104 is able to provide version control.

With additional reference to FIG. 7B, a variant of the blockchain 512 of FIG. 7A is shown. In FIG. 7B, the document 514 is encrypted when stored in the blockchain. As shown in block 704, an encrypted version of the document is stored in the payload data. The encrypted version is generated by encrypting the document with a symmetric encryption key K_{S1}. The symmetric encryption key may be referred to as a “content key” as it is used to encrypt the content (e.g., documents) stored in the blockchains managed by the system 104. The symmetric encryption key may vary with time and/or with each additional block added to a given blockchain. For example, the symmetric encryption key may be generated each time a document or new version of a document is to be stored in a block. The symmetric encryption key may be generated each time a new block is to be added, and is used in the encryption of the payload data of each block. An encrypted version of the symmetric encryption key E(K_{S1}) may be generated by encrypting the symmetric encryption key K_{S1} with a public key of a public-private key pair. The public key may correspond to the public key of the user that requested the saving of the document. The encrypted symmetric encryption key E(K_{S1}) is stored in the payload data for this block 704. The document management system 104 may manage the public-private key pairs of the users, and may thus have the private key corresponding to the public key that encrypted the symmetric encryption key K_{S1}, thereby allowing the document management system 104 to be able to access the document when needed. Similarly, block 710, has an encrypted second version of the document stored in its payload data, where the encrypted version is generated by encrypting the second version of the document with a second symmetric encryption key K_{S2}. This symmetric encryption key K_{S2} is encrypted with the public key of the public-private key pair of the another user with user identifier 1103 (i.e., different from the first user with user identifier 1101 that requested the saving of the document in block 704), and the encrypted symmetric encryption key E(K_{S2}) is stored in the payload data for this block 710. The encryption of the documents may be according to the encryption technique described in U.S. Patent Application Publication No. 2018/0331824, the contents of which are hereby incorporated be reference.

While FIG. 7B shows that the user identifiers and the encrypted symmetric encryption keys are stored in the payload data, in some embodiments, the user identifiers and the encrypted symmetric encryption keys are stored in metadata. For example, the entire payload data of a given block may be encrypted with the symmetric encryption key, where the payload data comprises the document, and the user identifier and the encrypted symmetric encryption key are stored in the metadata.

Any blockchain creation or appending of a block may be considered an event, which may be identified with the block identifier. The blockchain therefore corresponds to a timeline of the actions and status of the document represented by the blockchain, thereby providing an accurate and verifiable record of events. That is, blocks are only added to the blockchain and never removed, which effectively maintains an audit trail. As is common in blockchain technology, untraceable modification of existing blocks is prevented by adding in each new block a timestamp, a cryptographic hash signature of the previous block, and a hash signature of the payload of the current block. Going back and changing a block would make it no longer correspond to the next block's hash signature. In other words, a complete historical record is maintained such that the system can be used to see the state of the document at any point in the past to revisit what happened to the document and when.

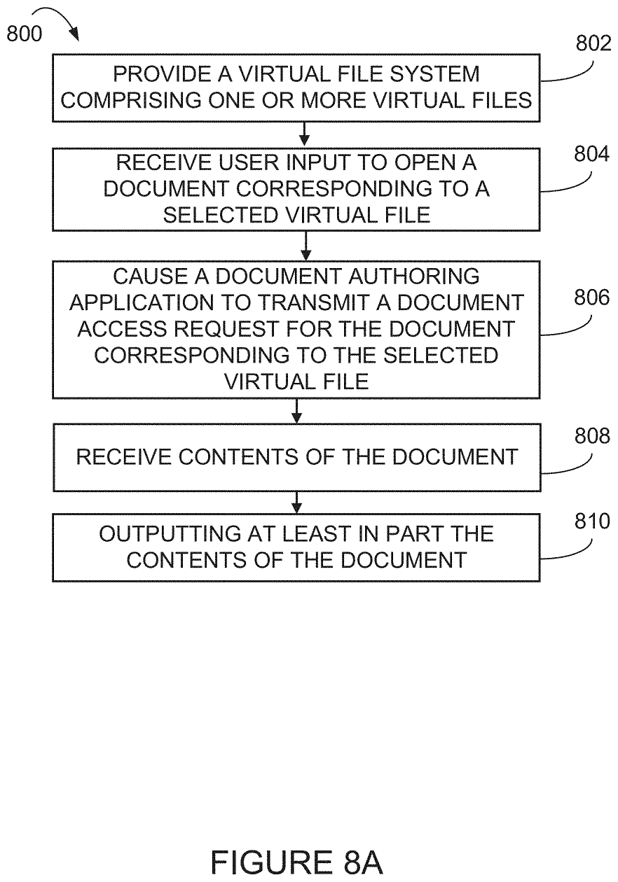

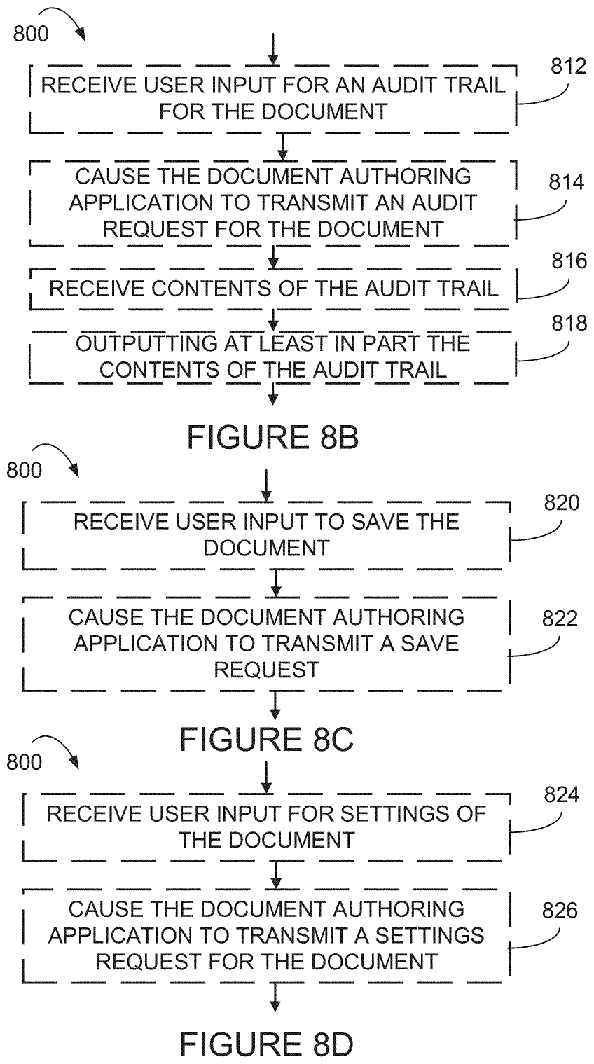

With reference to FIG. 8A, there is shown a flowchart illustrating an example method 800 for accessing a document by a computing device, such as the computing device 202. The steps of the method 800 may be performed by a processing unit of the computing device 202. Any reference to the environments, embodiments, and/or examples illustrated by FIGS. 1 to 7B in explanation of the method 800 is provided for example purposes and the operating environment for the performance of the method 800 may vary depending on practical implementations. Any aspects of the environments, embodiments, and/or examples illustrated by FIGS. 1 to 7B may be incorporated into the method 800.

At step 802, a virtual file system 230 is provided by the computing device 202. The virtual file system 230 comprises one or more virtual files. Each one of the one or more virtual files corresponds to a respective document stored in a blockchain by a document management system 104. Each virtual file comprises metadata comprising a blockchain reference indicative of a corresponding blockchain managed by the document management system 104. Each version of a respective document may be stored by a separate block in a corresponding blockchain. Alternatively, the changes or the deltas between different version may be stored as separate blocks. The virtual file system 230 may be provided in response to the computing device 202 being authenticated by the document management system 104. For example, the virtual file system 230 may be provided in response to a user associated with the computing device 202 being authenticated by the document management system 104. One or more users associated with the computing device 202 may have access to the same virtual file system 230. One or more users associated with the computing device 202 may have access to different virtual file systems 230. For example, a set of users may have access to the same virtual file system 230. By way of another example, each users in a set of users may respectively have access to a different virtual file system 230. The virtual file system 230 may be provided by at least one document management system interface 320, such as, the shell extension 410 and/or the background service running on the computing device 202.

At step 804, user input to open a document 514 corresponding to a selected virtual file 504 of the one or more virtual files is received by the computing device 202. The selected virtual file 504 corresponds to a document 514 stored in a blockchain 512 by the document management system 104. The selected virtual file 504 comprises a blockchain reference 508 indicative of the blockchain 512 having stored therein the document 514. The blockchain 512 may store multiple versions of the document 514. Each saved version of the document 514 may be stored in its entirety in a separate block of the blockchain 512. The blockchain reference 508 is stored in the metadata 506 of the selected virtual file 504. The user input to open the document 514 may be received via the virtual file system 230. For example, the user may double click on the selected virtual file 504. The document management system interface 320 (e.g., the shell extension 410 and/or the background service running) may intercept and override the file opening event by the operating system of the computing device 202. By way of another example, the user may select the selected virtual file 504 and then selects an option to open the selected virtual file 504. The user input to open the document 514 may be received via the document authoring application 102. The user may interact with the graphical user interface window 526 (e.g., a graphical user interface window of the document authoring application 102, a graphical user interface window of a web-browser running on the computing device 202, etc.) to provide the user input to open the selected virtual file 504. The add-in 120 may intercept and override the file opening event by the document authoring application 102.

Step 806 comprises causing the document authoring application 102 to transmit a document access request for the document 514 corresponding to the selected virtual file 504 to the document management system 104. The document access request comprises the blockchain reference 508 obtained from the virtual file 504. The document access request may be for the latest version or for a previous version of the document 514. The document access request may comprise an indicator of which version of the document 514 is being requested. Step 806 varies depending on whether the document authoring application 102 is running on the computing device 202 or on the remote computing infrastructure 250. When the document authoring application 102 is running on the computing device 202, causing the document authoring application 102 to transmit the document access request comprises transmitting, by the document authoring application 102, the document access request to the document management system 104. When the document authoring application 102 is running on the remote computing infrastructure 350, causing the document authoring application 102 to transmit the document access request comprises transmitting instructions (e.g., via the web-browser) for opening the document 514 corresponding to the selected virtual file 504 to the document authoring application 102 running on the remote computing infrastructure 350.

At step 808, contents of the document 514 corresponding to the selected virtual file 504 is received by the computing device 202. The entire contents of the document 514 or partial contents of the document 514 may be received at step 808. Step 808 varies depending on whether the document authoring application 102 is running on the computing device 202 or on the remote computing infrastructure 250. When the document authoring application 102 is running on the computing device 202, receiving the contents of the document 514 comprises receiving, by the document authoring application 102, a temporary file 516 comprising the contents 520 of the document 514 corresponding to the selected virtual file 504. The temporary file 516 may comprise a blockchain reference 508 corresponding to the blockchain 512 storing the document 514. In some embodiments, the temporary file 516 is not stored locally in a storage device at the computing device 202, but is stored in memory of the computing device 202 (unless the document authoring application 102 stores a temporary version, for example). When the document authoring application 102 is running on the remote computing infrastructure 350, receiving the contents of the document 514 comprises receiving, by the computing device 202, the contents of the document 514 corresponding to the selected virtual file 504 (e.g., via a web-browser running on the computing device 202) from the document authoring application 102 running on the remote computing infrastructure 350.

Step 810 comprises outputting at least in part the contents of the document 514 by the computing device 202. The outputting of contents of the document 514 is for display by the computing device 202 (e.g., for display at a display device of the computing device 202 or for display connected to the computing device 202). The entire contents of the document 514 or partial contents of the document 514 may be output. The contents of the document 514 that is outputted at step 810 may vary depending on the portion of the document 514 that is being viewed by the user. When the document authoring application 102 is running on the computing device 202, outputting at least in part the contents of the document 514 comprises obtaining the contents 520 from the temporary file 516, and outputting at least in part the contents 520.

In some embodiments, the user input at step 804 is to open a previous version of the document 514 (i.e., not the latest version of the document 514). Accordingly, in some embodiments, the document access request of step 806 is for a previous version, and may specify which previous version the user would like to open, and the contents of the document received at step 808 is of the previous version (e.g., the temporary file comprises the content of the previous version). The temporary file corresponding to the previous version of the document may have stored in its metadata an indicator that the document is read-only. When the document 514 is read-only, the user may be prohibited from modifying and/or saving any modifications to the previous version as a new version of the document. For example, if the user attempted to save the previous version as a new version, the add-in 120 may detect and intercept the save request, override the document saving by the document authoring application, not transmit a document save request to the document management system 104, and indicate to the user that saving this version of the document is prohibited.

In some embodiments, the method 800 further comprises overriding automatic saving (which may be referred to as “autosaving” or “autosave”) of the document authoring application 102. The add-in 120 may be configured to detect when the document authoring application 102 attempts to autosave the document 514, and not transmit a document save request to the document management system 104. The add-in 120 may prevent the document authoring application 102 from saving a location version of the document 514 when an autosave of the document is detected.

With additional reference to FIG. 8B, in some embodiments, the method 800 further comprises, at step 812, receiving user input for an audit trail of the document 514 corresponding to the selected virtual file 504. The user input for the audit trail may be received through the web-based interface 530 of the document authoring application 102. For example, the user may click on a button or a tab in the web-based interface 530 to request the audit trail. Alternatively, in some embodiments, the audit trail may be automatically requested when the user requests opening of the document, and/or when the contents of the document is received at step 808, the audit trail may also be received.

In some embodiments, the method 800 further comprises, at step 814, causing the document authoring application 102 to transmit an audit request for the document 514 to the document management system 104. The audit request comprises the blockchain reference 508. The blockchain reference 508 transmitted as part of the audit request may be obtained from the temporary file 516. Accordingly, the blockchain reference 508 provided in the audit request may be of the temporary file 516. Step 814 varies depending on whether the document authoring application 102 is running on the computing device 202 or on the remote computing infrastructure 250. When the document authoring application 102 is running on the computing device 202, causing the document authoring application 102 to transmit the audit request comprises transmitting, by the document authoring application 102, the audit request to the document management system 104. When the document authoring application 102 is running on the remote computing infrastructure 350, causing the document authoring application 102 to transmit the audit request comprises transmitting instructions (e.g., via the web-browser) for the audit trail to the document authoring application 102 running on the remote computing infrastructure 350.

In some embodiments, the method 800 further comprises, at step 816, receiving, by the computing device 202, contents of the audit trail of the document. The entire contents of the audit trail or partial contents of the audit trail may be received at step 816. Step 816 varies depending on whether the document authoring application 102 is running on the computing device 202 or on the remote computing infrastructure 250. When the document authoring application 102 is running on the computing device 202, receiving the contents of the audit trail may comprise receiving, by the document authoring application 102, the contents of the audit trail. When the document authoring application 102 is running on the remote computing infrastructure 350, receiving the contents of the audit trail comprises receiving, by the computing device 202, the contents of the audit trail (e.g., via a web-browser running on the computing device 202) from the document authoring application 102 running on the remote computing infrastructure 350.

In some embodiments, the method 800 further comprises, at step 818, outputting, by the computing device 202, at least in part the contents of the audit trail. The outputting of contents of the audit trail is for display by the computing device 202 (e.g., for display at a display device of the computing device 202 or for display connected to the computing device 202). The entire contents of the audit trail or partial contents of the audit trail may be output. The contents of the audit trail that is outputted at step 818 may vary depending on the portion of the audit trail that is being viewed by the user. The contents of the audit trail may be outputted to the web-based interface 530.

With additional reference to FIG. 8C, in some embodiments, the method 800 further comprises, at step 820, receiving user input to save a new version of the document. The user input to save the new version of the document is received via the graphical user interface window corresponding to the document authoring application 102 (e.g., a web-browser or a graphical user interface window of the document authoring application 102). For example, the user input may be received when the user clicks on the save button or icon. The add-in 120 may intercept and override the file save event by the document authoring application 102, and thus prevent a local save of the document.

In some embodiments, the method 800 further comprises, at step 822, causing the document authoring application to transmit a document save request comprising the current version of the document to the document management system 104. The document save request may comprise the current version of the document and the blockchain reference 508. The current version that is transmitted by the document save request corresponds to the temporary file at the time the save is being requested. The add-in 120 may detect that a save is being requested from the user, override the saving mechanism of the document authoring application 102, and transmit the save request to the document management system 104. The add-in 120 may be configured to monitor the local autosaving of the document by the document authoring application 102, block the autosaving of the document from occurring, and the document is only saved at the document management system 104 when the user requests a save.

The method shown in FIG. 8C may be used to request that a new document be created by the document management system 104 in the form of a blockchain. In this case, the save request does not contain a blockchain reference. Rather, the save request comprises an indicator that a new document is to be created by the document management system 104 in the form of a new blockchain. In this case, the save request is a new document creation request. The web-based interface 530 in the document authoring application 102 may be used to enter a file identifier in order for the document management system 104 to know what matter this document relates to. This may be used to associate the newly created document to an evidence matter managed by the system 104. In the case that user creates a new document directly in the virtual file system 230, the shell extension 410 and/or background service 420 interfaces with the document management system 104 (e.g., the shell extension 410 makes the REST calls) to have the file created at the document management system 104 in the form of a new blockchain, which causes a virtual file to be shown in the folder of the virtual file system 230. Accordingly, step 822 may be omitted, and the method 800 may further comprises the shell extension 410 and/or background service 420 intercepting a shell file creation request and transmitting the new document creation request to the document management system 104.

With additional reference to FIG. 8D, in some embodiments, the method 800 further comprises, at step 824, receiving user input to set one or more settings of the document. The user input set the document settings may be received through the web-based interface 530 of the document authoring application 102. For example, the user may select and/or enter-in the document settings (e.g., document permissions, file name, etc.) through the web-based interface 530. The various document settings that may be set by the user may be as described in relation to FIGS. 6A and 6B.

In some embodiments, the method 800 further comprises, at step 826, causing the document authoring application to transmit a settings request to the document to the document management system 104. The setting request comprises the document settings as set by the user and the blockchain reference 508.

In alternative embodiments, step 806 may be omitted and in its place, the shell extension 410 and/or the background service 420 may transmit the document access request to the document management system 104. Accordingly, the method 800 may further comprises the shell extension 410 and/or background service 420 intercepting a shell file access request and transmitting the document access request to the document management system 104.

Various steps of the method 800 may be performed by the add-in 120. For example, the add-in 120 may perform one or more of the following: transmit the document access request, receive the temporary file, transmit the audit request, receive the audit trail and output the audit trail, transmitting the save request or new document creation request, and/or transmitting the settings request.

The order of the steps of the method 800 may vary depending on practical implementations. Similarly, when suitable, some steps of the method 800 described may be combined and/or omitted.

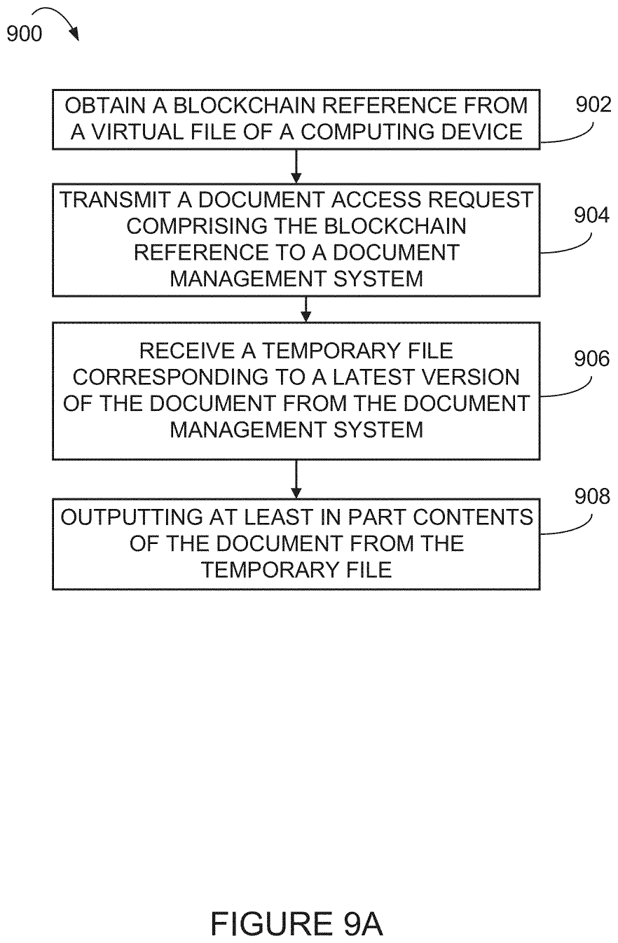

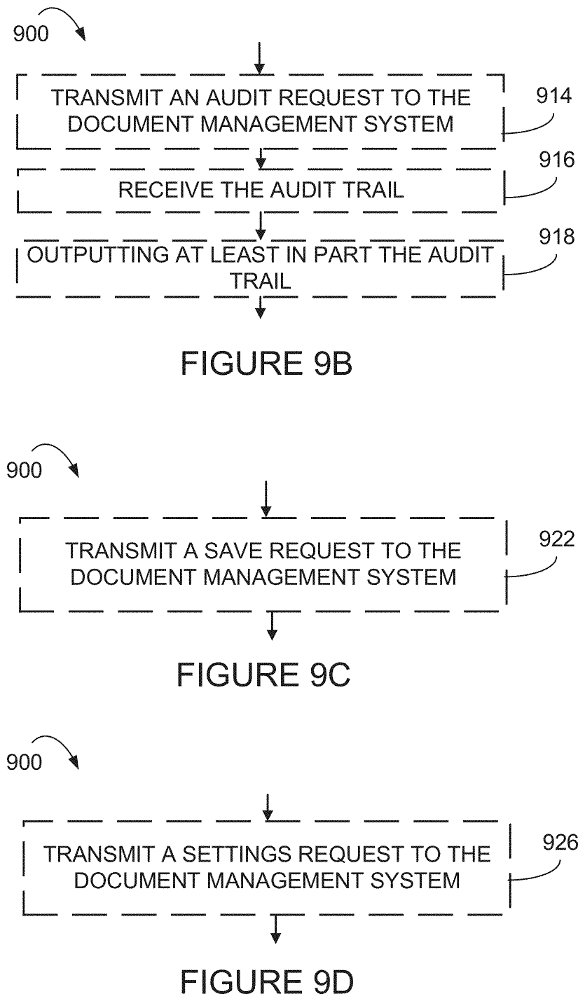

With reference to FIG. 9A, there is shown a flowchart illustrating an example method 900 for accessing a document by a document authoring application, such as the document authoring application 102. The steps of the method 900 may be performed by a processing unit of the computing device 202 or by a processing unit of the remote computing infrastructure 250, depending on where the document authoring application 102 is running. Any reference to the environments, embodiments, and/or examples illustrated by FIGS. 1 to 7B in explanation of the method 900 is provided for example purposes and the operating environment for the performance of the method 900 may vary depending on practical implementations. Any aspects of the environments, embodiments, and/or examples illustrated by FIGS. 1 to 7B may be incorporated into the method 900. Various aspect and/or steps of the method 800 may be incorporated into the method 900, and vice versa.

At step 902, a blockchain reference 508 from a virtual file 504 of the computing device 202 is obtained by the document authoring application 102. The virtual file 504 corresponds to a document 514 stored in a blockchain 512 by a document management system 104 remote from the computing device 202. The blockchain reference 508 is indicative of the blockchain 512 having stored therein the document 514. The blockchain reference 508 is obtained in response to user input to open the document 514 corresponding to the virtual file 504 (e.g., as described at step 804 of method 800, etc.).

At step 904, a document access request is transmitted to the document management system 104 by the document authoring application 102. The document access request comprising the blockchain reference 508. The document access request may be transmitted by the add-in 120. The document access request may be as described elsewhere in this document (e.g., as described at step 806 of method 800, etc.).

At step 906, a temporary file 516 corresponding to a latest version of the document 514 is received by the document authoring application 102 from the document management system 104. The temporary file 516 may be received by the add-in 120. The temporary file 516 and the receipt thereof may be as described elsewhere in this document (e.g., as described at step 808 of method 800, etc.)

Step 908 comprises outputting, by the document authoring application 102, at least in part contents of the document 514 from the temporary file 516. The outputting of the contents of the document 514 may be as described elsewhere in this document (e.g., as described at step 810 of method 800, etc.)

With additional reference to FIG. 9B, in some embodiments, the method 900 further comprises, at step 914, transmitting, by the document authoring application, an audit request for an audit trail of the document 514 to the document management system 104. The audit request comprises the blockchain reference 508. The audit request may be transmitted in response to receiving user input for the audit trail. The audit request may be transmitted from the add-in 120. The audit request and the transmission thereof may be as described elsewhere in this document (e.g., as described at step 814 of method 800, etc.). In some embodiments, the method 900 further comprises, at step 916, receiving, by the document authoring application, the audit trail from the document management system 104. The audit trail may be received by the add-in 120. The audit trail and the receipt thereof may be as described elsewhere in this document (e.g., as described at step 816 of method 800, etc.). In some embodiments, the method 900 further comprises, at step 918, outputting, by the document authoring application, at least in part the audit trail. The audit trail may be outputted by the add-in 120. The outputting of the audit trail may be as described elsewhere in this document (e.g., as described at step 818 of method 800, etc.).

With additional reference to FIG. 9C, in some embodiments, the method 900 further comprises, at step 922, transmitting, by the document authoring application, a document save request to the document management system 104. The save request may be transmitted in response to user input to save the document. The save request may be to save a new version of a document 514. The save request may be a new document creation request, and may be transmitted in response to user input to create a new document. The add-in 120 may transmit the document save request. The document save request and the transmission thereof may be as described elsewhere in this document (e.g., as described at step 822 of method 800, etc.).

With additional reference to FIG. 9D, in some embodiments, the method 900 further comprises, at step 926, transmitting, by the document authoring application, a settings request to the document management system. The settings request may be transmitted in response to user input to set or update the settings of the document. The settings request may be transmitted from the add-in 120. The settings request and transmission thereof may be as described elsewhere in this document (e.g., as described at step 826 of method 800, etc.).

Various steps of the method 900 may be performed by the add-in 120. For example, the add-in 120 may perform one or more of the following: transmit the document access request, receive the temporary file, transmit the audit request, receive the audit trail and output the audit trail, transmitting the save request, and/or transmitting the settings request.

The order of the steps of the method 900 may vary depending on practical implementations. Similarly, when suitable, some steps of the method 900 described may be combined and/or omitted.

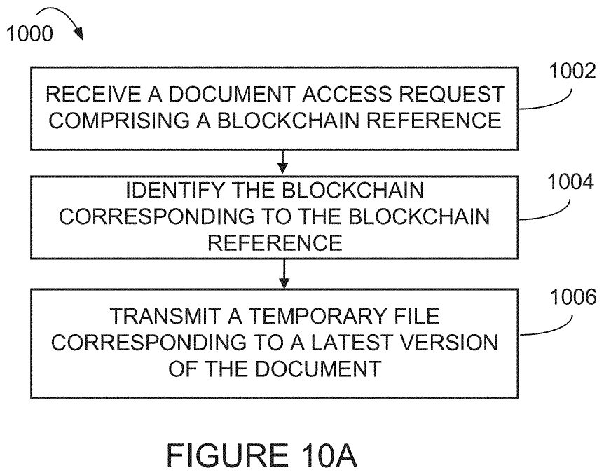

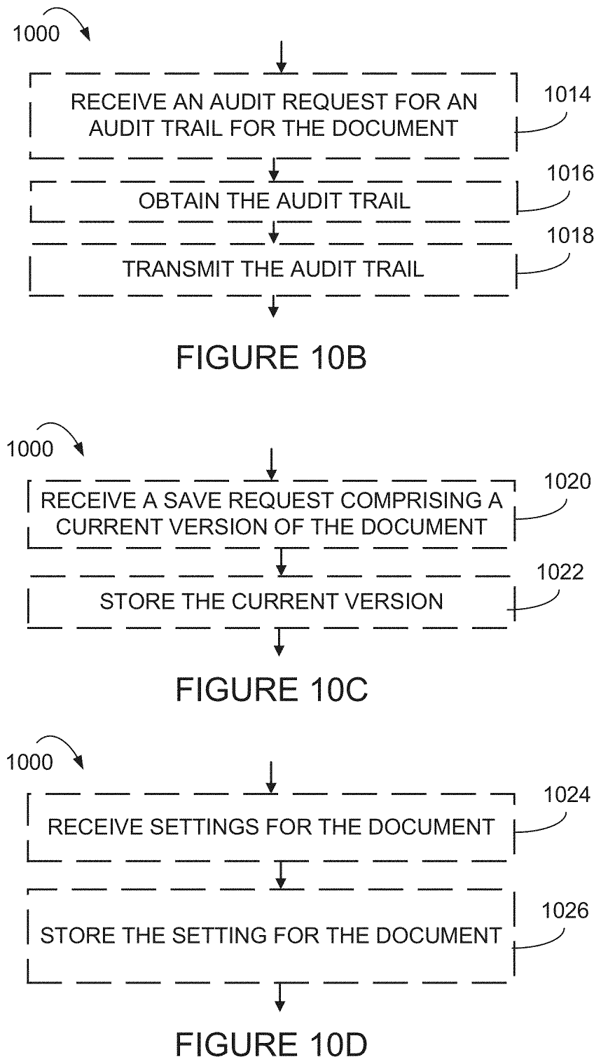

With reference to FIG. 10A, there is shown a flowchart illustrating an example method 1000 for accessing a document by a document management system, such as the document management system 104. The steps of the method 1000 may be performed by a processing unit of the document management system 104. Any reference to the environments, embodiments, and/or examples illustrated by FIGS. 1 to 7B in explanation of the method 1000 is provided for example purposes and the operating environment for the performance of the method 1000 may vary depending on practical implementations. Any aspects of the environments, embodiments, and/or examples illustrated by FIGS. 1 to 7B may be incorporated into the method 1000. Various aspects described in relation to the method 800 and/or method 900 may be incorporated into the method 1000, and vice versa.

At step 1002, a document access request to access a document 514 is received by the document management system 104. The document access request comprises a blockchain reference 508 indicative of a blockchain 512 having stored therein the document 514. The document access request may be as described elsewhere in this document (e.g., as described at step 806 of method 800, step 904 of method 900, etc.).

At step 1004, the blockchain 512 corresponding to the blockchain reference 508 is identified by the document management system 104. The blockchain reference 508 is obtained from the document access request, and the document management system 104 searches for the blockchain 512 corresponding to the blockchain reference 508. The document management system 104 may have a database (e.g., an index or a register 700) that stores blockchain references and the corresponding address of a last block for each blockchain reference. This database may be search with the blockchain reference 508 to identify the blockchain 512 corresponding to the blockchain reference 508 and/or the last block 710 of the blockchain 512 corresponding to the blockchain reference 508. The document access request may specify that the latest version of the document is being requested. The document management system 104 accesses a block 710 of the blockchain 512 storing a latest version of the document. The block storing the latest version of the document may or may not be the last block in the blockchain. For example, if document settings were updated after the last save of the document, the last block may be a document settings updated block and the second last block may store the document.

Alternatively, in some embodiments, when the document access request is for a previous version of the document 514, the document management system 104 accesses a block (e.g., block 704) of the blockchain 512 storing the requested previous version of the document 514. The document access request may specify which one of multiple previous version of the document 514 that is being requested. That is, the document access request may provide an indicator of which previous version of the document 514 is being requested. The document management system 104 may identify which one of the blocks of the blockchain 512 comprises the requested previous version based on the indicator of which previous version is being requested, and obtain the previous version of the document 514 from that identified block.

At step 1006, a temporary file 516 corresponding to the latest version of the document 514 is transmitted by the document management system 104 to the document authoring application 102. The temporary file 516 may be transmitted to the computing device 202, when the computing device 202 is running the document authoring application 102. The temporary file 516 may be transmitted to the remote computing infrastructure 250, when the remote computing infrastructure is running the document authoring application 102. The temporary file may be transmitted to the add-in 120. Alternatively, in some embodiments, when the document access request is for a previous version of the document 514, the document management system 104 transmits a temporary file 516 corresponding to the previous version of the document 514 (i.e., the contents of the temporary file 516 correspond to the requested previous version of the document 514).

With additional reference to FIG. 10B, in some embodiments, the method 1000 further comprises, at step 1014, receiving, by the document management system 104, an audit request for an audit trail of the document 514 from the document authoring application 102. The audit access request comprising the blockchain reference 508.

In some embodiments, the method 1000 further comprises, at step 1016, obtaining, by the document management system 104, the audit trail of the blockchain 512 corresponding to the blockchain reference 508. The audit trail may be generated from one or more commit logs. The commit log may be any suitable data structure or database. The commit log may be a tree data structure. For example, each blockchain may have a commit log that indexes that blockchain. The commit log stores summary information of each block added to that blockchain, such as one or more of: a new document has been created, a document has been viewed, a document has been edited, the user identifier, the timestamps, etc. The commit log may be identified using the blockchain reference 508. In some embodiments, for example when a commit log is not maintained or when the authenticity of the audit trail is required, the blockchain 512 corresponding to the blockchain reference 508 may be identified and then traversed to generate the audit trail. The audit trail may comprise one or more of: a document creation event corresponding to the creation of the blockchain that the document is stored therein; one or more view events of the document corresponding to each view of the document, one or more edit events of the document corresponding to each edit of the document, one or more document settings update events corresponding to each update to the documents settings. Each document creation event, each view event, each edit event, and/or each document settings update event may comprise user information (e.g., a user identifier, a user name, etc.) of the user associated with that event and/or a timestamp of the date and time of the occurrence of that event.

In some embodiments, the method 1000 further comprises, at step 1018, transmitting, by the document management system 104, the audit trail to the document authoring application 102. The audit trail may be transmitted to the add-in 120.

With additional reference to FIG. 10C, in some embodiments, the method 1000 further comprises, at step 1020, receiving, by the document management system 104, a document save request comprising a current version of the document 514 and the blockchain reference 508.

In some embodiments, the method 1000 further comprises, at step 1022, storing, by the document management system 104, the current version of the document 514 to the blockchain 512. In some embodiments, step 1022 comprises identifying the blockchain 512 from a plurality of blockchains managed by the document management system 104 using the blockchain reference 508 of the save request, and adding the current version as a new block in the blockchain 512. The entire document 514 may be stored in the new block. It should be appreciated that by storing each version of the document 514 in its entirety in separate blocks of the blockchain 512 that the complete historical record is maintained such that the system can be used to see the state of the document at any point in the past to revisit what happened to the document and when, which may be done via the audit trail request. Alternatively, the change or the delta between version of the document 514 may be stored in the new block. The register 700 may be updated so the last block pointer for the blockchain reference 508 points to the new block.

The new block may be generated by obtaining the hash signature (which is referred to as the “previous hash signature”) of the last block (which is referred to as the “previous block”) of the blockchain 512 prior to the addition of this new block, storing the current version of the document in the payload data of this new block, generating a current hash signature of the payload data of this new block, and storing the current hash signature and the previous hash signature in the metadata of this new block. Other information may be stored in the metadata and/or payload data of the new block, for example, as is described in relation to FIGS. 7A and 7B. For instance, the metadata of the new block may further comprise a timestamp of the date and time that the new block was generated, and the payload data or metadata of the new block may further comprise a user identifier of the user that requested that the current version of the document be saved.

In some embodiments, step 1022, comprises generating an encrypted version of the current version of the document 514 based on encrypting the current version of the document 514 with a symmetric encryption key (e.g., the symmetric encryption key K_{S2}), generating an encrypted version of the symmetric key based on encrypting the symmetric encryption key with a public key of a user that created the current version of the document 514, and storing in the new block the encrypted version of the new current of the document 514 and the encrypted version of symmetric key. In some embodiments, each time a new block is added to the blockchain, a symmetric encryption key is generated. This symmetric encryption key may be used to encrypt the payload data of that block. Once the payload data is encrypted, the symmetric encryption key may be encrypted with the public key of the user associated with the new block being created (e.g., the user that request that a new version of the document be saved). The encrypted version of the symmetric encrypt key is stored to the block (e.g., in the metadata) and the (unencrypted) symmetric encryption key is discarded (i.e., not stored in the blockchain or elsewhere by the system 104). The user identifier of the user is also stored in the block (e.g., in the metadata).

In embodiments where encryption is used to encrypt the document stored in the blockchain, decryption is used to access the document. In some embodiments, accessing the block (storing the latest version or a previous version of the document) of the blockchain at step 1004 comprises: obtaining the private key of the user that created the version of the document stored in the block (the current version or the previous version) based on a user identifier stored in the block; decrypting the encrypted symmetric encryption key stored in the block with the private key to obtain the symmetric encryption key; and decrypting an encrypted version of the document stored in the block with the symmetric encryption key to obtain the document (the current version or a previous version of the document). The system 104 may comprise a registry (e.g., a data structure or database) that stores the private keys of the users, and may use the user identifier in the block to obtain the private key of the user associated with the user identifier. The private key corresponds to a private key of a public-private key pair for the user, where the public key of the public-private key pair was used to encrypt the document or the payload of the block that has the document stored therein. Accordingly, the private key is associated with a public key, which together form a public-private key pair. Decrypting the encrypted version of the document stored in the block may comprise decrypting encrypted payload data that was encrypted with the symmetric key, where the encrypted payload data comprises the document.

The method shown in FIG. 10C may be used to create, by the document management system 104, a new document in the form of a new blockchain. In this case, the save request does not contain a blockchain reference. Rather, the save request comprises an indicator that a new document is to be created. In this case, the save request is a new document creation request. The new document creation may or may not comprise a document that is to be saved in this new blockchain. In this case, step 1022 is omitted, and the method 1000 further comprises creating a new blockchain for the new document, and optionally storing the document in a new block for this blockchain, for example, when the new document creation request comprises the document. In some embodiments, an empty document is a stored in the new block, for example, when the new document creation request does not comprise a document. In other words, the current version of the document may be an empty document. The document stored in the new block may or may not be encrypted, depending on implementation.

The encryption may be performed in a similar manner to that described above. Creating a new blockchain may comprise obtaining a start block, for example, as described in relation to FIG. 7A. Obtaining the start block may comprise receiving the start block from an external trusted system. Obtaining the start block may comprise generating the start block. Generating the start block may comprise adding the start block to a global blockchain managed by the document management system 104. The start block may comprise the blockchain reference for this newly created blockchain, which may be stored in the metadata or the payload data of the start block.

When the new blockchain is created, a register 700 may be updated to include a blockchain reference for that new blockchain and a pointer to the last block of the blockchain (e.g. the start block). After the start block is added, a new document created block (e.g., such as block 704 of FIG. 7A or 7B) may be added to the blockchain, and the register 700 may be updated so the last block pointer for the blockchain reference of this blockchain points to the new document created block.

With additional reference to FIG. 10D, in some embodiments, the method 1000 further comprises, at step 1024, receiving a settings request. The settings request comprises the blockchain reference 508 and settings for the document 514 corresponding to the blockchain reference 508. In some embodiments, the method 1000 further comprises, at step 1026 storing the settings request. The document settings of the settings request may be stored as a new block in the blockchain 512. This may include identifying the blockchain 512 corresponding to the blockchain reference 508 and creating a new block having stored therein the document settings. The creation of the new block for the document settings may be generated in a similar manner to that described elsewhere in the document. The new documents settings block may be generated by obtaining the previous hash signature of the previous block of the blockchain 512, storing the document settings in the payload data of this new block, generating a current hash signature of the payload data of this new block, and storing the current hash signature and the previous hash signature in the metadata of this new block. Other information may be stored in the metadata and/or payload data of the new block. By way of example, when the user sets or updates the file name for the document, a new documents settings block may be added to the blockchain, where the payload data comprises the file name for the document. By way of another example, when the user sets or updates the data access permissions, a new documents settings block may be added to the blockchain, where the payload data comprises the data access permissions. This approach may be performed for setting and/or updating any of the following: a record number that the document belongs to; an incident number that the document belongs to; a status of the document, the record, and/or the incident; a category of the document, the record, and/or the incident; a department; an incident start and/or end time; and a description for the document and/or the incident.

The order of the steps of the method 1000 may vary depending on practical implementations. Similarly, when suitable, some steps of the method 1000 described may be combined and/or omitted.

In alternative embodiments, the virtual file system may be omitted, and the document authoring application 102 may interface with the document management system 104 to obtain files.

In alternative embodiments, the document authoring application 102 may be a file editing application and the document management system 104 may be file management system, where the file editing application is configured to interface with the file management system. For example, the file editing application may be configured to edit video files and the file management system may be configured to store any suitable files, including video files.

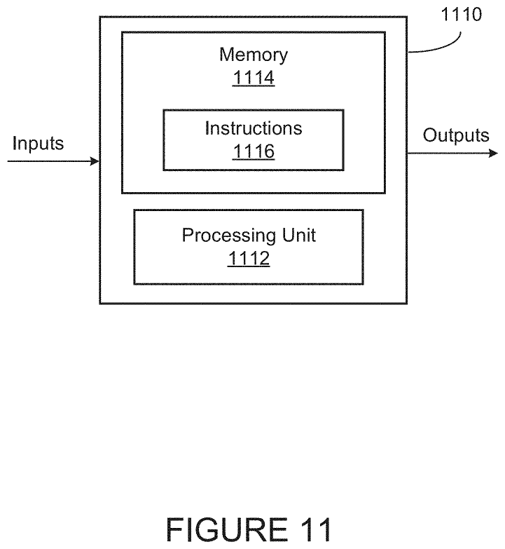

With reference to FIG. 11, the method(s) 800, 900 and/or 1000, may be implemented by at least one computing device 1110, comprising at least one processing unit 1112 and at least one memory 1114 which has stored therein computer-executable instructions 1116. The computing infrastructure of the auditable document management system 104 may comprise one or more computing device, such as the computing device 1110. Accordingly, the computing infrastructure of the auditable document management system 104 may comprise at least one processing unit 1112 and at least one non-transitory computer-readable memory 1114 having stored thereon program instructions executable by the at least one processing unit 1112 for implementing any of the functionality of the document management system 104 described herein. The computing device 202 may be implemented by one or more of the computing device 1110. The remote computing infrastructure 250 may comprise one or more computing device, such as the computing device 1110. The storage device(s) 450 may be implemented by one or more memory 1114.

The computing device 1110 may comprise any suitable devices configured to implement the method(s) 800, 900 and/or 1000 such that instructions 1116, when executed by the computing device 1110 or other programmable apparatus, may cause the functions/acts/steps performed as part of the method(s) 800, 900 and/or 1000 as described herein to be executed. The processing unit 1112 may comprise, for example, any type of general-purpose microprocessor or microcontroller, a digital signal processing (DSP) processor, a central processing unit (CPU), a graphical processing unit (GPU), an integrated circuit, a field programmable gate array (FPGA), a reconfigurable processor, other suitably programmed or programmable logic circuits, or any combination thereof.

The memory 1114 may comprise any suitable known or other machine-readable storage medium. The memory 1114 may comprise non-transitory computer readable storage medium, for example, but not limited to, an electronic, magnetic, optical, electromagnetic, infrared, or semiconductor system, apparatus, or device, or any suitable combination of the foregoing. The memory 1114 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1114 may comprise any storage means (e.g., storage devices) suitable for retrievably storing machine-readable instructions 1116 executable by processing unit 1112. Memory 1114 may be used to store one or more databases.

The methods and systems described herein may be implemented in a high level procedural or object oriented programming or scripting language, or a combination thereof, to communicate with or assist in the operation of a computer system, for example the computing device 1110. Alternatively, the methods and systems may be implemented in assembly or machine language. The language may be a compiled or interpreted language. Program code for implementing the methods and systems may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems may also be considered to be implemented by way of a non-transitory computer-readable storage medium having a computer program stored thereon. The computer program may comprise computer-readable instructions which cause a computer, or in some embodiments the processing unit 1112 of the computing device 1110, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

What is claimed is:

1. A method for accessing a document by a document authoring application, the method comprising:
obtaining, by the document authoring application, a blockchain reference from a virtual file of a computing device, the virtual file corresponding to a document stored in a blockchain by a document management system remote from the computing device, the blockchain reference indicative of the blockchain having stored therein the document;
transmitting, by the document authoring application, a document access request to the document management system, the document access request comprising the blockchain reference;
receiving, by the document authoring application, a temporary file corresponding to a latest version of the document from the document management system; and
outputting, by the document authoring application, at least in part contents of the document from the temporary file.

2. The method of claim 1, further comprising:
transmitting, by the document authoring application, an audit request for an audit trail of the document to the document management system, the audit request comprises the blockchain reference;
receiving, by the document authoring application, the audit trail from the document management system; and
outputting, by the document authoring application, at least in part the audit trail.

3. The method of claim 2, wherein the document authoring application comprises a software add-in for obtaining the blockchain reference, transmitting the document access request, receiving the temporary file, transmitting the audit request, receiving the audit trail and outputting the audit trail.

4. The method of claim 2, wherein the temporary file further comprises the blockchain reference; and wherein the audit request comprises the blockchain reference of the temporary file.

5. The method of claim 1, wherein the temporary file further comprises the blockchain reference, the method further comprising:
transmitting, by the document authoring application, a document save request to the document management system, the document save request comprises the blockchain reference of the temporary file and a current version of the document.

6. The method of claim 1, wherein the document authoring application is running on the computing device, and wherein the method further comprises providing, by the computing device, a virtual file system comprising the virtual file, the virtual file system corresponding to documents stored in blockchains by the document management system and authorized to be accessed by the computing device.

7. The method of claim 6, wherein a shell extension and/or a background service runs on the computing device, and wherein the shell extension and/or the background service provide the virtual file system.

8. The method of claim 6, wherein obtaining the blockchain reference comprises retrieving the blockchain reference from the virtual file in response to a user request via the virtual file system to open the document corresponding to the virtual file.

9. The method of claim 1, wherein obtaining the blockchain reference comprises retrieving the blockchain reference from the virtual file in response to a user request via the document authoring application to open the document corresponding to the virtual file.

10. The method of claim 1, wherein the document has multiple versions and each version of the document is stored by a separate block of the blockchain.

11. The method of claim 1, wherein the document authoring application is running on at least one server remote from the computing device.

12. A method for accessing a document by a computing device, the method comprising:
providing, by the computing device, a virtual file system comprising one or more virtual files, each one of the one or more virtual files corresponding to a respective document stored in a blockchain by a document management system;
receiving, by the computing device, user input to open a document corresponding to a selected virtual file of the one or more virtual files, the selected virtual file comprises a blockchain reference indicative of the blockchain having stored therein the document;
causing a document authoring application to transmit a document access request for the document corresponding to the selected virtual file to the document management system, the document access request comprising the blockchain reference;
receiving, by the computing device, contents of the document corresponding to the selected virtual file; and
outputting, by the computing device, at least in part the contents of the document.

13. The method of claim 12, further comprising:
receiving user input for an audit trail of the document;
causing the document authoring application to transmit an audit request for the document to the document management system, the audit request comprises the blockchain reference;
receiving, by the computing device, contents of the audit trail of the document;
outputting, by the computing device, at least in part the contents of the audit trail.

14. The method of claim 13, wherein the document authoring application is running on the computing device; and
wherein causing the document authoring application to transmit the document access request comprises transmitting, by the document authoring application, the document access request to the document management system; and
wherein causing the document authoring application to transmit the audit request comprises transmitting, by the document authoring application, the audit request to the document management system.

15. The method of claim 14, wherein receiving the contents of the document comprises receiving, by the document authoring application, a temporary file comprising the blockchain reference and the contents of the document corresponding to the selected virtual file;
wherein the audit request comprises the blockchain reference of the temporary file; and
wherein receiving the contents of the audit trail comprises receiving, by the document authoring application, the audit trail.

16. The method of claim 15, wherein the document authoring application comprises a software add-in for transmitting the document access request, receiving the temporary file, transmitting the audit request, receiving the audit trail and outputting the audit trail.

17. The method of claim 12, further comprising:
receiving user input to save a current version of the document; and
causing the document authoring application to transmit a document save request to the document management system, the document save request comprises the blockchain reference and the current version of the document.

18. The method of claim 12, wherein the document authoring application is running on at least one server remote from the computing device and accessible by the computing device via a web browser running on the computing device.

19. The method of claim 12, wherein the document has multiple versions and each version of the document is stored by a separate block of the blockchain.

20. A method for accessing a document by a document management system, the method comprising:
receiving a document access request to access a document from a document authoring application, the document access request comprising a blockchain reference indicative of a blockchain having stored therein the document;
identifying the blockchain corresponding to the blockchain reference and accessing a block of the blockchain storing a latest version of the document; and
transmitting a temporary file corresponding to the latest version of the document to the document authoring application.

21. The method of claim 20, further comprising:
receiving an audit request for an audit trail of the document from the document authoring application, the audit access request comprising the blockchain reference;
obtaining the audit trail of the blockchain corresponding to the blockchain reference; and
transmitting the audit trail to the document authoring application.

22. The method of claim 21, wherein receiving the document access request from the document authoring application comprises receiving the document access request from a software add-in of the document authoring application configured to interface the document authoring application with the document management system; and
wherein receiving the audit request comprises receiving the audit request from the software add-in of the document authoring application.

23. The method of claim 20, further comprising:
receiving a document save request from the document authoring application, the document save request comprises the blockchain reference and a current version of the document;
identifying the blockchain corresponding to the blockchain reference of the document save request; and
storing the current version of the document as a new block of the blockchain.

24. The method of claim 23, wherein storing the current version comprises:
generating an encrypted version of the current version of the document based on encrypting the current version of the document with a symmetric encryption key;
generating an encrypted version of symmetric key based on encrypting the symmetric encryption key with a public key of a user that created the current version of the document; and
storing in the new block the encrypted version of the current version of the document and the encrypted version of symmetric key.

25. The method of claim 20, wherein accessing the block of the blockchain storing the latest version of the document comprises:
obtaining a private key of a user that created the latest version of the document based on a user identifier stored in the block;
decrypting an encrypted symmetric encryption key stored in the block with the private key to obtain a symmetric encryption key; and
decrypting an encrypted version of the document stored in the block with the symmetric encryption key to obtain the latest version of the document.
